(19) United States
(12) Patent Application Publication
(10) Pub. No.: US 2026/0294603 A1
(43) Pub. Date: Oct. 1, 2026

(54) INSERTION UNIT FOR ELECTRIC PERSONAL CARE DEVICE

(71) Applicant: TRISA HOLDING AG, Triengen (CH)

(72) Inventors: Fabian KELLER, Kaltbach (CH); Stefan SCHERZINGER, Willisau (CH)

(73) Assignee: TRISA HOLDING AG, Triengen (CH)

(21) Appl. No.: 19/479,580

(22) PCT Filed: Apr. 26, 2024
(86) PCT No.: PCT/EP2024/061615

§ 371 Date: Oct. 28, 2025

(30) Foreign Application Priority Data
Apr. 28, 2023 (EP) 23170573.2

(51) Int. Cl. A61C 17/22; A46B 13/02; A46B 17/08; H02J 7/70

(52) U.S. Cl. CPC A61C 17/224; A46B 13/02; A46B 17/08; H02J 7/70

(57) ABSTRACT

An insertion unit for a handpiece of an electric personal care device, in particular an electric toothbrush, including an insertion carrier on which a drive unit, an on/off switch, a power source, a printed circuit board and a charging device are arranged, wherein the insertion unit is configured in such a way that a closed circuit can be established with it alone, wherein the insert carrier includes a charging device carrier in the area of the charging device and wherein the charging device carrier and/or the charging device form part of the outer surface of the handpiece when assembled; as well as a corresponding handpiece and a corresponding personal care device, in particular an electric toothbrush.

### TECHNICAL FIELD

The invention relates to an insertion unit for a handpiece of an electric personal care device, in particular an electric toothbrush, as well as a corresponding handpiece and a corresponding personal care device, in particular an electric toothbrush.

The product design of electric personal care devices, in particular electric toothbrushes, nowadays comprises in particular a housing, an insertion unit (which consists of several components, one or more of which can penetrate the housing at least partially), a closure cap and a plug-on brush.

The assembly generally comprises manufacturing the housing, equipping and providing the insertion unit, and manufacturing the closure cap, whereby the insertion unit is inserted into the housing and the closure cap is attached to the housing, thereby closing the interior of the housing.

In systems with direct charging (charging via a physical electrical connection), the charging socket is usually located inside the device and the housing is sealed with a closure cap to prevent water from entering the housing.

### PRIOR ART

WO 2016/177580 A1 discloses an electric toothbrush in which the battery is inserted into a battery compartment of the carrier element from behind when the closure cap is open, or a rechargeable battery is located in the battery compartment of the carrier element and the closure cap is then attached to the handpiece, whereby turning the closure cap locks it in place and closes the circuit. When assembled, the battery is indirectly connected to the printed circuit board via a first contact plate at the first pole and a second contact plate at the closure cap. The circuit is closed via the closure cap.

The closure cap is therefore used not only to close the interior of the housing but also to physically close the circuit; the insertion unit is therefore not functional on its own.

WO 2019/072994 A1 describes an electric toothbrush in which the closure cap is fixed to the housing during assembly so that it secures the insert unit and closes the interior of the housing. The closure cap can be screwed to the housing or locked in place using a bayonet lock, for example.

According to WO 2022/128207 A1, the insertion unit or its individual components are mounted on a frame unit (monoframe) consisting of two half-shell-like halves. First, the individual components are inserted into the first half-shell-like half and fixed with the second half-shell-like half. Then the frame unit is pushed into the housing. Finally, the housing cover is screwed onto the housing and locked or fixed in place.

These solutions each require a closure cap opposite the housing, as the electric toothbrushes are preferably charged inductively (i.e. not directly with a physical electrical connection) on a charging station.

The present invention is therefore based on the object of providing an electric toothbrush in which the number of components can be reduced. A further object of the invention is to provide an electric toothbrush with simple charging handling.

### SUMMARY OF THE INVENTION

The object is solved according to the invention by an insertion unit for a handpiece of an electric personal care device as defined in claim 1, as well as by a handpiece for an electric personal care device as defined in independent claim 21, and an electric personal care device, in particular an electric toothbrush, as defined in claim 22. The object is further solved by an insertion unit for a handpiece of an electric personal care device as defined in claim 23, as well as by a handpiece for an electric personal care device as defined in independent claim 31 and an electric personal care device, in particular an electric toothbrush, as defined in claim 32. Advantageous embodiments of the invention are disclosed in the dependent claims.

The essence of the invention consists of the following: an insertion unit for a handpiece of an electric personal care device, in particular an electric toothbrush, which has an insertion carrier on which a drive unit, an on/off switch, a power source, a printed circuit board and a charging device are arranged. The insertion unit is configured in such a way that it can be used to create a closed circuit on its own and is therefore functional on its own. The insertion carrier comprises a charging device carrier in the area of the charging device, and the charging device carrier and/or the charging device form part of the outer surface of the handpiece when assembled.

This means that charging takes place directly on the device without having to remove a closure cap or lid. This also reduces the number of components required, as it is possible to dispense with a closure cap plastic part, a closure cap contact plate, a contact on the insertion unit and a sealing ring, since the circuit no longer needs to be closed with the closure cap.

The term “insertion carrier” refers to structures, in particular frame-like support structures, on which the individual components of the plug-in unit can be arranged with sufficient stability to ensure trouble-free insertion into the housing and subsequent safe use of the device.

The term “drive unit” refers to all suitable motors, especially electric motors, like DC or AC motors. The device's drive types include vibrating drives (e.g., motor with eccentric for a vibrating movement with standard head on the plug-on brush), swiveling-oscillating drives (e.g., left-right swiveling movement with standard head on the plug-on brush), and oscillating-rotating drives (e.g., left-right rotating movement with round head on the plug-on brush).

In the case of the vibrating drive, the movement comprises a vibration generated by a motor with a connected eccentric. The motor speed ranges from 8′000 rpm to 15′000 rpm.

In the case of the swiveling-oscillating drive, the movement of the drive shaft (from its basic position) covers an angle range of +/−1° to +/−15°, preferably +/−3° to +/−10°. The motor speed in the unloaded state is from 7′000 rpm to 12′000 rpm, preferably from 9′000 rpm to 11′000 rpm. This results in 15′000 to 25′000 movements per minute.

In the case of the oscillating-rotating drive, the movement of the drive shaft (from its basic position) covers an angle range of +/−10° to +/−40°, preferably from +/−20° to +/−30° and most preferably +/−25°. The movement of the brush head from its basic position, i.e. the angle of rotation of the bristle carrier is +/−15° to +/−40°, preferably +/−20° to +/−30° when unloaded. The motor speed in the unloaded state is 3′500 rpm to 10′000 rpm, preferably 4′000 rpm to 7′000 rpm. This results in 7′000 to 10′000 movements per minute.

Left and right rotations from the center position of the brush head are calculated as movement. The bristle field is aligned differently to the drive shaft/axis of rotation depending on the drive. With an oscillating-rotating drive, the bristle field is virtually perpendicular to the drive shaft and the bristles are aligned parallel to the axis of rotation of the bristle carrier. In the case of a pivoting-oscillating drive, the bristle field is aligned perpendicular to the drive shaft, which corresponds to the axis of rotation.

The term “printed circuit board” refers in particular to structures such as circuit boards, circuit cards, plates and printed circuits. The printed circuit board is connected in particular to the charging device, the power source, the drive unit, and the on/off switch. All electrical connections in the device are connected to the printed circuit board. The connections can be made by means of electrical wires/cables or plug or contact connections; for example, in the case of the on/off switch, via a mechanical or electrical coupling.

The term “on/off switch” in this context includes both (in particular single-pole) mechanical and electronic pressure switches.

The term “energy source” in this context refers in particular to all suitable accumulators (rechargeable batteries) or batteries (disposable or reusable batteries).

The phrase “can be used to create a closed circuit on its own” is understood in particular to mean that a closed circuit can be created via physical electrical lines/cables and/or suitable plug-in contact elements between the components arranged on the slide-in carrier without the slide-in unit having to be inserted into the corresponding device.

The “part of the outer surface of the handpiece” refers in particular to the rear part of the surface of the handpiece, which comprises the charging device. The outer surface may comprise, in particular, essentially horizontal (i.e. essentially parallel to the longitudinal axis of the handpiece) or essentially vertical (i.e. essentially perpendicular to the longitudinal axis of the handpiece) areas, but may also comprise outwardly curved areas. The charging device carrier and/or the charging device are in any case partially open to the outside.

In this context, the term “charging device” refers in particular to a device for directly charging the corresponding device, i.e., in principle without the need for an inductive charging station, for example. The charging device thus comprises, in particular, charging sockets via which charging is carried out by means of a power supply unit having a plug corresponding to the charging socket. However, it is also conceivable that the charging device could be designed as an inductive device.

The term “charging device carrier” refers in this case to structures that ensure that the charging device is securely held in place on the insertion unit and that at least partially enclose and/or support the charging device. The charging device carrier is also regularly configured structurally to provide a seal between the insertion unit and the housing. The charging device is open to the outside.

Preferably, the charging device comprises a plug-in device, in particular a charging socket for a corresponding plug of a power supply unit. This form of direct charging has proven to be particularly efficient in practice.

Preferably, the charging device comprises an inductive device, in particular a charging coil, for example for inserting a corresponding ferrite core.

A combination of the two variants is also possible.

Preferably, the charging device carrier comprises a charging device carrier body and an end piece. The charging device carrier body regularly encloses the charging device, at least partially, whereby the charging device is open to the outside, and clamps it (in the assembled state) to ensure a secure hold. The end piece is usually the section of the charging device carrier that forms part of the outer surface of the corresponding device or forms the end of the surface towards the outside, i.e. in particular in the rear area of the device or handpiece, where the charging device is also located. The end piece can perform a protective function for the charging device as well as a handling function by being designed to allow the corresponding device to be positioned vertically. In this way, the usual closure cap can also be dispensed with.

Preferably, the charging device carrier is designed as a single piece. This is particularly efficient in terms of manufacturing. However, a multi-part design of the loading device carrier is also provided, whereby the loading device carrier comprises a separate end piece that can be locked into place with the loading device carrier body. However, the insertion unit forms a single unit and is inserted into the interior of the housing of the handpiece of the corresponding device as a whole, i.e., with the end piece latched to the charging device carrier body.

On the other hand, in the multi-part design of the charging device carrier, a separate end piece can be provided which can be attached to the charging device carrier body (straight), i.e., essentially form-fitting with, if necessary, a snap-fit or clamp fit. The insertion unit can in turn be inserted as a whole, i.e., with the end piece attached to the charging device carrier body, into the interior of the housing of the handpiece of the corresponding device.

The multi-part design allows end pieces of different designs to be installed, i.e., different sized bases or specific different designs.

Preferably, the charging device comprises a locking geometry, preferably hook-shaped, which is configured to cause the charging device to lock against the charging device carrier body when assembled. Furthermore, the charging device is preferably pressed into the charging device carrier body, whereby a form fit occurs which causes the charging device to be sealed relative to the charging device carrier body. The inner surface of the charging device carrier body is preferably designed to correspond to this and thus supports the pressing and sealing (e.g., by means of a taper in the direction of insertion). This serves to protect the interior of the housing and the charging device itself.

Preferably, the charging device carrier body has a first sealing zone opposite a housing of a handpiece, preferably in the form of a first groove for receiving a first sealing element (e.g. an O-ring), which are configured to seal the insertion unit against the housing wall of the handpiece when assembled. In this way, the ingress of water or moisture and contaminants can be effectively prevented.

Preferably, the charging device carrier body has a second sealing zone opposite a housing of a handpiece, preferably in the form of a second groove for receiving a second sealing element (e.g., an O-ring), which are configured to effect a seal of the insertion unit against the housing wall of the handpiece when assembled. This second sealing element is arranged in front of the first sealing element when viewed in the insertion direction of the insertion unit and provides additional sealing if necessary. However, it is also conceivable to use only the second (inner) sealing element.

Preferably, in a multi-part design of the charging device carrier (i.e. in particular in the plug-on variant for the end piece), the charging device carrier body has a sealing zone opposite the end piece, preferably in the form of a groove for receiving a sealing element (e.g. an O-ring), which is configured to effect an axial seal of the charging device carrier body opposite the end piece when assembled. This sealing zone provides additional protection in the multi-part design. Furthermore, the end piece preferably also has a sealing zone opposite the housing of a handpiece, preferably in the form of a groove for receiving a sealing element (e.g. an O-ring), which is configured to effect a lateral seal of the insertion unit opposite the housing wall of the handpiece when assembled. This double seal provides optimum protection for this variant of the multi-part design of the charging device carrier.

In general, sealing elements can also be realized as injection-molded elements made of soft components, so that the sealing element does not need to be assembled, as the element is already injection molded during the injection molding process.

Preferably, the charging device and/or the charging device carrier body form part of the outer surface of the handpiece, which runs essentially perpendicular to the longitudinal axis of the handpiece. This creates an effective base for standing the device upright and ensures open accessibility to the charging device.

Preferably, the end piece of the charging device carrier forms part of the outer surface of the handpiece. This allows the end piece to form, in particular, a substantially ring-shaped protective element for the charging device (in particular the charging socket pin), which at the same time defines an insertion opening for, for example, a plug of a corresponding power supply unit. Here, too, the design is preferably such that the device can be safely placed in a vertical position.

Preferably, one or more locking tabs are arranged on the charging device carrier body, which are configured to lock into corresponding locking recesses in the housing wall of the handpiece when assembled. In this way, a robust anchoring of the insertion unit to the housing is achieved.

Preferably, the locking tabs have a wedge-like shape with an insertion bevel, a horizontally extending part and a substantially vertical rear wall. This design has proven to be particularly effective, as the locking tabs with the rear wall at the back (i.e., opposite the insertion direction) rest against the corresponding walls of the locking recesses in the housing wall.

Preferably, the charging device carrier is mounted resiliently on a support structure (of the insertion unit) by means of a spring bearing. In particular, the spring bearing comprises a first spring clip and a second spring clip, which are preferably arranged independently of each other between the charging device carrier and the support structure. In this way, a particularly effective length compensation function can be provided (according to this embodiment, the charging device carrier presses against the end piece and thus the insertion unit into the housing).

Preferred non-powered components that can be implemented in the insertion unit and are installed in or on the device include motion detectors such as gyroscopes or motion sensors and lighting devices such as infrared lamps. Accordingly, a non-powered product can also be implemented with other electrical components using a corresponding insertion unit.

Another aspect of the invention comprises a handpiece for an electric personal care device, in particular for an electric toothbrush, which has a housing and an insertion unit in accordance with the above specifications.

Yet another aspect of the present invention comprises an electric personal care device, in particular an electric toothbrush, which has a handpiece according to the above specifications.

Further or supplementary preferred embodiments for the individual parts or components are described below.

The housing of the handpiece generally serves to position and guide the insertion unit, which is determined at least in part by the shape of the insertion carrier and/or the entire (i.e., equipped) insertion unit and the space configuration within the housing. Separate guides or positioning elements are not necessarily required; rather, this can be determined solely by the geometric design of the insertion carrier and/or the equipped insertion unit itself.

Possible positioning or guide elements provided to ensure force transmission between the housing and the insertion unit must ensure that the insertion unit cannot rotate in the housing and that the insertion unit is clearly positioned at the same time.

The following explanations apply in particular in connection with the one-piece design of the insertion unit or the corresponding charging device carrier.

Preferred elements here are snap-in recesses in the housing or the inner wall of the housing, which are implemented in the hard component respectively the hard plastic shell and, if necessary, are also provided with soft components. The locking recesses are positioned longitudinally, measured from the side of the open end of the housing (insertion side), in the rear 50% of the length of the insertion unit, preferably in the rear 30% of the length of the insertion unit (i.e. along the longitudinal axis of the insertion unit).

The positioning in the circumferential direction is such that the locking recesses can be arranged regularly or irregularly along the circumference, but a symmetrical arrangement (i.e. top opposite bottom or front opposite rear) is preferred. The locking recesses are preferably arranged at the front (towards the top) and at the rear (towards the back); the angle between the locking recesses measured from the longitudinal axis or base line is between 20° and 90°, preferably between 30° and 60°.

The dimensions of the locking recesses in the housing are, with regard to the length in the direction of the longitudinal axis, from 0.3 mm to 3 mm, preferably from 0.5 mm to 2 mm. The width measured in the transverse direction is from 1 mm to 5 mm, preferably from 1.5 mm to 4 mm.

The hole or locking recess is preferably not open from the outside and is generally implemented in the hard component or hard plastic shell of the housing, for example as a blind hole. If it is implemented as a through hole in the hard component, the soft component can close off part of the through hole, whereby the soft component can be arranged in such a way that it is later displaced at least partially by the locking tab.

The depth in the finished housing is from 0.2 mm to 2 mm, preferably from 0.3 mm to 1 mm.

The number of locking recesses is from 2 to 8, preferably from 3 to 4.

The locking recesses preferably have a symmetrical structure (i.e., with respect to the longitudinal axis or a plane containing the longitudinal axis) or a regular structure (i.e., with respect to the cross-sectional plane and the division of the angles).

With regard to the shape of the locking recesses, it is generally important to ensure during manufacture that they can be removed from the mold. The layout of the locking recesses is usually rectangular, preferably oblong (i.e., they have a rounded, approximately rectangular shape). The locking recesses are preferably shaped such that a straight wall is perpendicular to the longitudinal axis of the handpiece or housing. When assembled, this wall interacts with the corresponding locking tab.

In terms of depth, the shape is preferably a straight cylinder or a cylindrical shape on a rectangular or oblong base. A conical or truncated cone shape is also conceivable.

With regard to guidance, positioning, and force transmission, it should be noted that the insertion unit is inserted into the housing of the handpiece, whereby the positioning and the stop are preferably realized in one. The geometry or cross-sectional shape of the insert prevents the insertion unit from rotating. In other words, a clear positioning is specified, with the shape of the front part of the insertion unit in particular determining the alignment.

The insertion unit rests against the housing in various areas. Longitudinal guides are provided, which define the alignment of the insertion unit with protruding elements. The end position is only reached when the unit is inserted correctly, with the (vibration) motor at the front of the housing. In particular, the motor is at an angle, preferably acute, to the longitudinal axis of the housing, with the stop being implemented flat at an angle to the longitudinal axis in the housing.

When inserted correctly, the locking tabs engage in the corresponding locking recesses when the stop is reached, i.e., they rest against the front of the housing and the locking tabs engage (preferably at the rear) in the locking recesses on the housing.

The insertion unit with its individual components is preferably fixed in place by means of a tension between the latch and the stop. In between, the insertion unit or the individual components are largely free, i.e., there is only a point contact with the housing, if any.

The force is transmitted via the geometry of the insert. The lockings are free at the sides, i.e. the locking tabs preferably do not contact the locking recesses at the sides.

In a variant of the multi-part design of the insertion unit or the charging device carrier (in particular in the case of an oscillating-rotating drive), the insertion unit is preferably held in place by clamping between the end piece and the housing. The end piece can have its own closure, e.g., a snap closure, and seals the housing and the insert. Sealing is preferably achieved by means of two O-rings, which are arranged on the charging device carrier and/or on the end piece, depending on the design.

In another variant of the multi-part design of the insertion unit, the insertion unit is merely positioned and held in place, but not sealed against the end piece. The end piece is individually designed and preferably holds onto the insertion unit or the housing.

Further housing elements include interaction elements such as one or more switches made of soft components (i.e. among other things the on/off switch), which are intended for interaction with elements or components on the insertion unit. A recess for a pressure equalization element may also be provided, i.e., a through hole with a membrane for degassing the interior of the housing.

The insertion unit is functional on its own, i.e., no conventional closure cap or similar device is required to close the circuit. The function can be performed without any additional elements.

The insertion unit comprises the insertion carrier for the functional elements and, preferably, also one or more sealing elements for sealing the interior of the housing. Part of the insertion unit or the charging device carrier (preferably the end piece) also forms part of the outer product surface. The outer contour of the product is continued with the insert unit or the charging device carrier, resulting in a continuous surface (i.e., in particular without indentations, etc.).

In the one-piece design (preferably with the swiveling-oscillating drive), the charging device carrier (together with the rest of the insertion carrier) is made from one piece, and the various components are mounted on it. The insertion unit essentially extends over the entire length of the housing. Elements that form part of the outer geometry, i.e. primarily the end piece of the charging device carrier or the charging device carrier body or the charging device itself, are formed at the rear end, as the insertion unit is inserted into the insertion opening of the handpiece with the motor or eccentric shaft first.

The insertion unit is anchored and fixed in relation to the housing. Installation consists of inserting the insertion unit into the housing until it clicks into place. This creates an irreversible fixation, i.e. the insertion unit cannot be removed without damage after installation. The anchoring or fixing takes place in the locking recesses in the housing wall.

Corresponding locking tabs are arranged on the insert itself, which snap into the recesses in or on the housing, whereby the aforementioned recesses represent the counterpart to the locking tabs.

The structure of the locking tabs is wedge-shaped when viewed against the direction of insertion. The locking tabs initially comprise an insertion bevel or ramp which defines an angle alpha relative to the longitudinal axis (or a bevel relative to the base line in the solid material) in a range from 10° to 75°, preferably from 15° to 35°.

The length L1 of the base line of the insertion slope (measured in a straight line parallel to the longitudinal axis) is from 0.3 mm to 3 mm, preferably from 0.5 mm to 1.5 mm.

The height H of the insertion bevel or ramp is between 0.1 mm and 1.5 mm, preferably between 0.25 mm and 0.5 mm. The height increases steadily and then transitions into the horizontal section.

The horizontal section (parallel to the insertion direction) has a base line with a length L2 of 0.1 mm to 1 mm, preferably 0.15 mm to 2 mm. The height H is between 0.1 mm and 1.5 mm, preferably 0.25 mm to 0.5 mm (i.e. corresponding to the highest point of the insertion ramp).

The rear vertical wall (perpendicular to the longitudinal axis or the insertion direction) serves to actually snap into the locking recesses in the housing and therefore also has the height H.

The overall dimensions of the insertion bevel or ramp are therefore L1 plus L2 in length, from 0.4 mm to 4 mm, preferably from 0.65 mm to 3.5 mm, and in width (i.e., transverse to the longitudinal axis or the direction of insertion) from 0.5 mm to 3 mm, preferably from 0.8 mm to 2 mm, and in height from 0.1 mm to 1.5 mm, preferably from 0.25 mm to 0.5 mm.

The locking tabs may be spring-loaded. The spring action may be achieved by mounting the locking tabs on a springy substrate. This means that the charging device carrier or the charging device carrier body has springy elements or areas that support the locking tabs. For example, by means of a U-shaped recess in the substrate that supports the locking tabs.

The number of locking tabs preferably corresponds to the number of locking recesses, but there may also be more locking recesses than locking tabs. However, each locking tab snaps into a locking recess. The number of locking recesses is from 2 to 8, preferably from 3 to 4.

The position of the locking tabs is generally matched to the locking recesses in or on the housing. On the insertion unit, the positioning depends on the position of the insertion unit relative to the housing and the other components on the insertion unit.

The insertion unit or insertion carrier comprises various carrier areas or carrier zones for mounting various components on the insertion unit. It is intended that electrical elements are electrically connected to each other or with each other. The individual areas of the insertion carrier are described in detail below.

The motor carrier (motor zone) is intended for mounting the motor, whereby the motor is held and fixed in an inclined position, for example. Mounting is carried out from the front. The eccentric protrudes from the zone for the motor and thus from the insertion carrier.

The switch carrier (switch zone) is intended for mounting the on/off switch. Installation is carried out from the front. The switch carrier is usually located directly adjacent to the motor carrier or between the motor carrier and the battery carrier.

The battery carrier (battery zone) is used to attach the battery. The battery is connected to the printed circuit board by means of soldered contact plates, for example, and the battery is clamped to the battery carrier, which is located between the battery and the printed circuit board when assembled. The battery is mounted from the top. The battery carrier is located between the switch carrier and the charging device carrier. A connecting carrier can also be connected to the battery carrier, which contains an empty space for routing the electrical lines or cables to the socket or for compensating for different battery lengths.

The charging device is mounted on the charging device carrier or the charging device carrier body along the longitudinal axis of the insertion unit. The charging socket is located on the inside and the sealing elements and locking tabs are located on the outside. The sealing elements (O-rings) are mounted from the motor along the longitudinal axis (i.e. against the direction of insertion) and the socket is mounted from the rear along the longitudinal axis (i.e. in the direction of insertion). The charging device carrier also comprises the end piece, which forms the rear end of the handpiece and forms part of the outer surface.

The printed circuit board carrier (print zone) carries the printed circuit board, which extends across several of the other carrier zones. Installation is carried out accordingly from the rear.

With regard to the charging functionality, there is a plug-in solution and an inductive solution for the energy source or battery, i.e. the device is charged either by direct plug-in (e.g. as a power supply unit with a plug or by means of a plug from a PC, e.g. USB plug), and on the other hand, an inductive charger can be provided with which the device can be charged (without a plug contact).

In the case of a charging socket (the integration into the product is described), this may comprise a standard device, such as a standard socket for a power supply plug. Possible variants include USB, USB-C, and Lightning-plugs. In principle, plugs of any size can be used. However, a seal with at least IPX7 protection class standard must be provided.

The charging device carrier is located at the rear end of the insertion unit. When assembled, the charging socket is preferably recessed into the charging device carrier body. The charging socket remains accessible at all times. The arrangement in the recess, preferably formed by the end piece, already offers a certain degree of protection against water, moisture or contamination.

The charging device carrier is preferably implemented parallel to the longitudinal axis of the housing. The end piece is generally not closed (unless the cover described above is provided), but remains accessible from the outside. The seal of the charging socket itself again complies with the IPX7 protection class standard.

In principle, instead of a charging socket, a coil body (for the insertion unit) can be integrated into the charging device carrier, which can be used for inductive charging. In this case, the charging device carrier is closed, as no opening is required for the charging socket or the corresponding plug of the power supply unit. This also means that no hole is required in the end piece and a corresponding sealing zone is therefore not necessary.

The following section discusses sealing functions in connection with the present invention.

The aim is to provide a general seal against the ingress of water or moisture and contamination. The sealing is done directly on the insertion unit, whereby no separate end piece is required for sealing in the one-piece design.

Depending on the design of the insertion unit or the charging device carrier, the following sealing zones can be considered for this purpose.

First, it is preferable to provide a seal between the charging device or the charging socket and the charging device carrier, with the seal being formed around the charging socket. The charging socket is pressed into the slot so that it is pressed between the charging socket and the material. In this regard, latching geometries or latching hooks are preferably provided on the charging socket. The charging socket is thus clamped into the charging device carrier. Additional sealing is provided by the fit of the charging socket pressed into the charging device carrier.

Furthermore, the insertion unit or the charging device carrier is preferably sealed against the housing, which is usually realized as a groove with an inserted O-ring that presses against the housing wall and seals it.

Furthermore, a design with double sealing is also possible. In this case, two grooves are provided on the insertion unit or the charging device carrier, with an O-ring inserted into each groove, so that double sealing is achieved.

In the best case, though, only one groove is needed, and it's best if it's the one that's against the free or rear end of the slide-in unit or the loading device carrier. However, to improve the seal, the second seal can also be provided as a precaution. Both grooves are regularly implemented in the finished insertion unit or the finished loading device carrier, but it is not necessary to use both.

Preferably, only the seal closer to the free or rear end of the handpiece is used. However, it is also conceivable to use only the groove (alone) located away from the free or rear end of the handpiece.

In the embodiment with the two-part loading device carrier (clip-on variant), the loading device carrier body presses against the end piece, whereby the seal is formed between the insertion unit and the end piece. The seal can be achieved by a fit (via the contact surface) or by means of a sealing ring in a groove on the loading device carrier body, whereby the seal is achieved by compression. In addition, the end piece can seal against the housing. The sealing position is either located laterally opposite the housing wall or at the rear end of the housing.

Another seal comprises a pressure equalization element, which is designed as a membrane applied to a hole in the housing. The function of the pressure equalization element is to enable the battery to degas, i.e., it is intended to allow gas to escape from the interior of the housing via the membrane.

The components of the pressure equalization element comprise a membrane with a diameter of approximately 5 mm and a through hole in the housing with a diameter of approximately 1 mm. This allows gas to escape and prevents water from entering.

The pressure equalization element can be located on the side of the housing wall, whereby it should be noted that application on a flat surface is preferable, as this allows for better adhesion than on a curved surface.

Alternatively, the pressure equalization element can also be located at the rear of or inside the end piece.

In products where the drive device protrudes from the housing, such as rotating-oscillating toothbrushes, two additional seals are provided, namely one between the housing and the insert unit or insert carrier in the outlet area of the drive device and another between the insert unit or insert carrier and the drive shaft in the outlet area of the drive device.

For products with a multi-part design of the charging device carrier, an additional zone is provided between the end piece and the housing.

O-rings and/or molded elements can be provided as sealing options. The O-rings are made of silicone or, preferably, acrylonitrile butadiene rubber (NBR).

The dimensions of the O-rings of the seal in the rear area of the slide-in carrier are, with regard to the diameter of the ring (i.e., in the middle of the strand), from 10 mm to 20 mm, preferably from 13 mm to 16 mm. The diameter of the strand itself is from 1 mm to 5 mm, preferably from 1.5 mm to 3.5 mm.

The molded elements are provided on the housing or on the slide-in unit or slide-in carrier as a further sealing option, in particular as a second seal between the slide-in unit or slide-in carrier and the housing (i.e. in particular in the case of a one-piece design of the loading device carrier). The end piece rests against the housing. On the housing, the soft component is molded into the contact area and the end piece rests against the soft component, thus creating a further sealing option.

In general, sealing elements can also be made as molded elements from soft components, so that the sealing element does not need to be assembled, as the element is already molded during the injection molding process.

The insertion carrier is usually made of a hard component, preferably POM. This has the advantage that dimensional stability is ensured, no water absorption occurs (which affects accuracy), and overall a more consistent seal is achieved through more precise positioning.

Additional optional features allow the device to stand upright on its own. The rear end of the housing is designed in such a way that the device can be placed on a flat surface with the longitudinal axis of the handpiece perpendicular to the surface. The rear end surface of the end piece is therefore flat. Preferably, materials are applied to the rear end surface which increase grip or have a certain surface adhesion.

Furthermore, a protective cap can be provided, i.e., not a conventional closure cap, because the charging socket should remain accessible at all times. However, if a cover is necessary, a protective cap made of a soft component can be provided, for example, which can be inserted into the insertion opening to protect the charging socket from water and dirt ingress.

The protective cap can be designed as a separate part or it can be molded onto the housing, in which case the protective cap is preferably connected to the housing via a material bridge. This connection is permanent and holds the protective cap to the housing.

In the following, we will now discuss essential aspects of the attachment brushes for electric toothbrushes or other brushes or personal care devices designed in accordance with the present invention.

For the brush heads according to the invention, (conventional) extruded bristles are preferably used, i.e. both in pointed and cylindrical form, formed from hard and/or soft components, preferably from polyamide (PA) or polyester (PBT).

Manufacturing can be carried out by extruding one material or by extruding more than one material (co-extrusion). In contrast to injection-molded bristles or rubber-elastic massage and/or cleaning elements, which are manufactured by injection molding, conventional bristles are extruded, cut, and, if necessary, processed before being inserted into the bristle carrier using a suitable method.

The longitudinal shape of the bristles or bristle filaments can be cylindrical, mechanically or chemically tapered (especially in the case of polyester (PBT)), wavy, twisted, and/or helical.

Preferred cross-sectional shapes are circular, round, triangular, rectangular, square, elliptical, polygonal, trapezoidal, parallelogram-shaped, or rhombus-shaped.

For oral hygiene products, the diameter is between 0.075 mm and 0.25 mm and the cross-sectional area is between 0.002 mm² and 0.2 mm². The diameter describes the smallest circle that can be formed around the cross-sectional shape of the bristle.

For cosmetic products, which are also conceivable in the present context as plug-on brushes, a diameter of 0.025 mm to 0.2 mm and a cross-sectional area of 0.001 mm² to 0.15 mm² are sufficient.

The surface of the bristles is preferably smooth or textured. The bristles are regularly grouped together in bundles.

In preferred embodiments, tongue cleaners may also be provided on the plug-on brushes, which are formed from hard components and/or soft components and/or combinations of hard components and soft components and/or material for injection-molded bristles. The tongue cleaners are regularly manufactured using injection molding.

The plastics preferably used as hard components in the present invention generally comprise styrene polymers such as styrene acrylonitrile (SAN), polystyrene (PS), acrylonitrile butadiene styrene (ABS), styrene methyl methacrylate (SMMA) or styrene butadiene (SB); polyolefins such as polypropylene (PP) or polyethylene (PE) (preferably also in the form of high-density polyethylene (HDPE) or low-density polyethylene (LDPE)); Polyesters such as polyethylene terephthalate (PET) in the form of acid-modified polyethylene terephthalate (PETA) or glycol-modified polyethylene terephthalate (PETG), polybutylene terephthalate (PBT), acid-modified polycyclohexylenedimethylene terephthalate (PCT-A) or glycol-modified polycyclohexylenedimethylene terephthalate (PCT-G); cellulose derivatives such as cellulose acetate (CA), cellulose acetate butyrate (CAB), cellulose propionate (CP), cellulose acetate phthalate (CAP) or cellulose butyrate (CB); Polyamides (PA) such as PA 6.6, PA 6.10 or PA 6.12; polymethyl methacrylate (PMMA); polycarbonate (PC); polyoxymethylene (POM); polyvinyl chloride (PVC); polyurethane (PUR) and/or polyamide (PA).

Polyethylene (PE) can be used in this case as both a hard component and a soft component. Similarly, polyurethane (PU) can be used as both a hard component and a soft component.

Polypropylene (PP) with a modulus of elasticity of 1000 to 2400 N/mm², preferably 1200 to 2000 N/mm², and particularly preferably 1300 to 1800 N/mm², is preferred.

Within the scope of the present invention, the hard component (or combinations thereof) is preferably used for or in unstable structural elements.

In the case of the electric toothbrush handle, these are basically the housing, the frame unit, the injection-molded joint piece with the joint pin, the connecting rod, the eccentric, the key element, and the housing cap.

For the plug-on brush according to the invention, these are basically the head section, the plug-on section, the neck section, and the bristle carrier.

If several hard components are used (for example, in two-component or multi-component injection molding) or if materials are joined by ultrasonic welding, the hard components used preferably form a material bond with each other.

Alternatively, several materials can be used which do not form a material bond in two-component or multi-component injection molding. In these pairings, a form fit is provided (e.g., by undercuts and/or breakthroughs as well as partial and/or complete overmolding, etc.).

The second injected hard component then shrinks onto the first injected hard component during cooling and forms a shrinkage bond. Examples of possible hard component pairings that do not form a material bond are polypropylene and polyester or polypropylene and styrene acrylonitrile.

Within the scope of the present invention, the soft component(s) are generally made of a thermoplastic styrene elastomer (TPE-S) (preferably a styrene-ethylene-butylene-styrene copolymer (SEBS) or styrene-butadiene-styrene copolymer (SBS)); a thermoplastic polyurethane elastomer (TPE-U); a thermoplastic polyamide elastomer (TPE-A); a thermoplastic polyolefin elastomer (TPE-O); a thermoplastic polyester elastomer (TPE-E) and/or silicones.

Soft components are used in the present invention, for example, in sprayed bristles, in cleaning and massage elements on the bristle carrier of a clip-on brush, in tongue cleaners on or on the bristle carrier of a clip-on brush, or as materials that improve grip on the handpiece and/or in the area of the switches on the handpiece.

Polyethylene (PE) and polyurethane (PU) can be used as both hard and soft components. Soft components are particularly preferred in this case to be thermoplastic elastomers (TPEs) with a Shore A hardness of less than 90, preferably less than 50 and even more preferably less than 30. The soft components preferably form a material bond with hard components during overmolding in a two-component or multi-component injection molding process.

Further preferably, the material(s) for the injection-molded bristles are formed from thermoplastic polyurethane elastomers (TPE-U). These have better flow properties than standard TPE and solidify more quickly (i.e., faster crystallization, with the molecular chains bonding even at high temperatures).

Alternative materials include polyethylene (PE), for example in the form of low-density polyethylene (LDPE) or linear low-density polyethylene (LLDPE), or thermoplastic polyester elastomers (TPE-E) or thermoplastic polyamide elastomers (TPE-A).

The materials for injection-molded bristles further preferably comprise soft components, preferably thermoplastic elastomers, and have a Shore D hardness of 0 to 100, preferably 30 to 80. Special forms of soft components are used for injection-molded bristles, which generally have higher Shore hardnesses than soft components used to manufacture soft-elastic cleaning/massage elements or handle zones or tongue cleaners, for example.

During the injection molding process (e.g., a two-component or multi-component injection molding process), the materials for injection-molded bristles do not usually bond with the other soft and/or hard components used (e.g., with a carrier plate or a bristle carrier). Consequently, a form fit is provided for any connections with other hard or soft materials (e.g., by undercuts and/or openings as well as partial and/or complete overmolding, etc.). The second material injected for the injected bristles shrinks during cooling to the first injected hard or soft component, thus forming a shrinkage connection.

Special materials that can generally be used in this context include bioplastics (i.e., plastics made from renewable raw materials) and water-soluble polymers.

Bioplastics consist at least partly of basic substances from the following raw materials. Suitable raw materials include, for example, corn, hemp, sugar, castor oil, palm oil, potatoes, wheat, sugar cane, rubber, wood, or the castor plant/miracle tree. Examples of basic substances include cellulose, starch, lactic acid (PLA), glucose, chitin, or chitosan.

The main groups of bioplastics preferred here include starch-based bioplastics, cellulose-based bioplastics, polyhydroxyalkanoates (e.g., polyhydroxybutyrate (PHB)), polylactic acid (PLA), or aliphatic/aromatic copolyesters. Other preferred bioplastics include lignin-based bioplastics.

The present invention is particularly applicable to brush products for personal hygiene. With regard to oral hygiene, electric toothbrushes are particularly suitable. These, in turn, use different types of movement, such as oscillating, pivoting, translational, and vibrating movements. However, combinations and overlaps are also possible.

Other electrical personal care devices relate in particular to the cosmetics sector, such as mascara brushes, nail polish brushes, facial brushes, applicators, and massage devices.

Electric toothbrushes comprise, in particular, mechanical drives with a gearbox (1:1 gearbox or gearbox with transmission or reduction), a vibrating armature, or an electric motor. The exact design depends on the desired speeds.

Disposable batteries or rechargeable batteries (lithium-ion batteries or nickel-metal hydride batteries) are used as energy storage devices, which are charged inductively or directly with a plug connection, if necessary.

In the following, relevant manufacturing and brushing methods will be described in general as well as on the basis of various preferred design variants.

Injection molding is generally carried out in an injection mold (or a corresponding machine), preferably in the form of multi-component injection molding. The materials can bond together either by material closure or by material connection. However, it is also possible that the materials do not bond, i.e., a shrinkage connection with mobility or a joint is created by means of a form closure. In general, hot runner, cold runner, or co-injection processes can be used. The position of the injection points can vary depending on the component, i.e., the injection points can be located at the front of the component, in the middle of the component, or at the rear of the respective component.

The preferred bristle insertion methods for the brush heads described here are, in particular, anchor punching methods and anchorless bristle insertion methods.

In the anchor punching method, the base body is first injection molded with corresponding blind holes for the bristles. The bristles are then folded and secured in the blind holes by means of anchors, which are regularly formed from punched wire (or separated from such wire). For the anchor punching method, a punching device, a punching tool, punched wire or anchors, and corresponding mold inserts are required in addition to the bristles.

A variant of anchor punching, which can also be used in the present case, is known as loop punching. In this process, the bristles are constricted by means of wire loops, which are also formed from punching wire, and inserted into the blind holes.

In anchorless bristle insertion processes, on the other hand, the bristles are not folded and no punching wire is used. Compared to the bristles from the anchor or loop punching process, the bristles are therefore only half as long.

The sequence of a first preferred method variant is as follows: First, the bristle bundles are separated, then the bristle ends are fused, and then the bristle ends are directly overmolded. The bristle bundles can generally be combined here, i.e., joined together to form a larger bundle. If the overmolding also includes injection molding of the handle, this is referred to as the “in-mold tufting” process (IMT process). If the bristles are first overmolded with plates and then the plates are overmolded with the handle, this is referred to as integrated anchorless production.

The sequence of a second preferred method variant is as follows: First, (separate) carrier plates for the bristles with through holes are injection molded, then the bristles are provided and guided through the carrier plate. Next, the rear ends of the bristles are melted and fused to the carrier plate, and finally the bristled carrier plate is ultrasonically welded to the handle, which is also manufactured separately. Bristle bundles may or may not be joined together during this process.

The sequence of a third preferred process variant is as follows: First, the base body with through holes for bristles in the head area is injection molded, then the bristles are prepared and fed through the through holes in the head area. The bristles are then fused on the back of the head area and the bristle melt is overmolded with soft material. Known methods include those in which it is not possible to merge bristles and those in which it is possible to merge bristles.

The fourth method is as follows: First, a base body with blind holes or recesses for the bristles is injection molded in the head area, then the bristles are prepared in bundles. The bristles are then fused in bundles, after which the base body in the head area (i.e., in particular the bristle carrier or bristle holder) is heated to approximately glass temperature, and finally the fused bristle ends are inserted into the blind holes or recesses and the bristle bundles are anchored in the bristle carrier under pressure. In other words, the size of the blind holes is reduced or the geometry of the bristle carrier or bristle carrier is deformed in order to anchor the bristle bundles.

Another preferred bristle insertion method is the twisting method. In this method, the bristle filaments are first fed, bundled, and pulled forward. In particular, the bristle filaments are fed from a roll. Several filament strands can be wound onto one roll. Several rolls are preloaded for machine feeding, as each bristle filament in the brush corresponds to one filament strand. The filaments are spread out appropriately so that they have the width required for insertion into the brush. The filaments are then pulled forward so that they are free for the next step, i.e., so that the wire can be guided over them.

The wire is now fed, cut, and bent. The wire is fed from a wire reel to the brushing machine (i.e., unwound) and introduced into the process. The wire is cut to a length that is greater than the unwound length of the twisted bristle filaments (the final cutting to length takes place after twisting). The wire is then bent into a U shape so that the open side can later be pushed over the filaments (this is also referred to as threading the bristles).

The filaments and the bent wire are now brought together. The wire is pushed over the filaments from the outside, with the wire being held in the bend or at the bottom of the U. The open end of the wire is then clamped so that the filaments are held between the pieces of wire. The filaments are then cut to a length that is greater than the final length in the brush so that the brush can be cut to size correctly after the filaments have been twisted in.

The filaments are then twisted in and profiled. This means that the wire is twisted so that the filaments are clamped or fixed between the wire. After the filaments have been clamped or fixed between the wire, they are cut to the desired length or profiled accordingly. Once the corresponding brush part has been completed, the excess wire is finally cut off.

Another aspect of the present invention consists of: an insert unit for a handpiece of an electric personal care device, in particular an electric toothbrush, comprising an insert carrier on which a drive unit, an on/off switch, a power source, a printed circuit board, and a contact element carrier are arranged. The insert unit is configured in such a way that a closed circuit can be established with it alone. Two contact elements are arranged on the contact element carrier, whereby the contact element carrier and the contact elements are configured to ensure elastic bending of the contact element by contact elements of a charging device carrier during assembly.

The term “elastic bending” is to be understood here as meaning that at least one section of the respective contact element (i.e., in particular, bending sections of a spring sheet) is held against the contact elements of the loading device carrier (i.e., in particular, against contact pins of a closure cover) in a quasi-resilient manner by means of a preload generated during assembly, so that the contact is not lost even in the event of shocks or vibrations.

The “contact element carrier” is preferably a plastic component whose geometry has various support and contact points for the contact elements, i.e. in particular the spring plates, whereby the support points ensure suitable guidance or bending of the respective spring plate around the contact element carrier (i.e. in particular in the case of a design of the spring plates in the form of a longitudinally halved mushroom cross-section) and whereby the contact points ensure, for example, electrical contact between the spring plate and the printed circuit board.

Preferably, the contact elements arranged on the contact element carrier are each designed in the form of a spring sheet. In this way, suitable geometries can be provided which can be formed to fit the contact element carrier and thus ensure secure contact with the contact pins of the closure cap when assembled.

Preferably, the contact elements of the charging device carrier are designed in the form of contact pins. This allows effective and secure contact to be established with the respective spring sheet or, in particular, with elastic bending sections thereof.

Preferably, the charging device carrier is designed in the form of a closure cover for the handpiece. This design allows different coupling shapes to be provided for various charging plugs.

Preferably, the closure cap comprises a retaining element into which the contact pins are inserted in such a way that their rear and front ends protrude freely from the retaining element, whereby the rear ends can be engaged with a plug and whereby the front ends can be brought into contact with the respective contact element of the contact element carrier. This design allows the closure cap to act in a particularly efficient manner as a carrier for a charging device on the one hand and as a contact maker with the insertion unit on the other.

Preferably, the spring plates have the shape of a mushroom cross-section halved lengthwise. In the arrangement, the two spring plates are symmetrical or mirror-symmetrical to each other and have opposite elastic bending sections in the area of the “stem” which engage with the contact pins of the closure cap during assembly. This makes it particularly easy to assemble the spring plates.

Preferably, the contact element carrier has concave guide projections between which the elastic bending sections of the spring plate arranged on the contact element carrier pass in such a way that they can be moved into recesses in the concave guide projections during assembly. This design ensures that the spring element is held particularly securely on the contact element carrier, as it also allows vibrations or shocks acting in the longitudinal direction of the handpiece to be absorbed.

Preferably, the charging device carrier or the closure cover has at least one magnetic element which is configured to interact with an external plug so that the plug comes into electrical contact with a charging device of the charging device carrier virtually by itself. This is particularly practical for a plug with a contact projection which can be inserted into the rear recess of the closure cap and brought into contact with the rear ends of the contact pins by means of corresponding recesses, for example. The plug may comprise corresponding magnets or contain magnetic material.

Another aspect of the invention comprises a handpiece for an electric personal care device, in particular for an electric toothbrush, comprising a housing, an insertion unit that can be inserted therein, and a charging device carrier according to one of the above specifications.

Yet another aspect of the invention comprises an electric personal care device, in particular an electric toothbrush, comprising a handpiece according to the above specifications.

In the following, further aspects of the present invention are described as solutions for direct charging of handpieces with round internal cross-sections. In these solutions, the insertion unit is again designed so that it can be operated autonomously. The housing is closed by the closure cap, which-for example in the manner of a bayonet closure-is connected to corresponding structures of the handpiece housing in a sealing manner by turning it. A round inner cross-section of the handpiece is necessary for such a twist lock.

An interface or coupling structure for charging the corresponding device is integrated into the closure cap itself (the closure cap therefore also acts as a charging device carrier). During assembly, an electrical connection must therefore be established between the coupling structure of the closure cap and the insertion unit in the handpiece. To do this, the insertion unit is first inserted into the handpiece of the corresponding device and then the cap is mounted.

The interface solutions preferably have a longitudinal orientation towards the outside and are implemented in the present case by the insertion unit and the closure cap. Alternatively, however, the interface could also be implemented directly on the insertion unit (whereby the closure cap and the insertion unit form a unit or a component) when used with the insertion unit. Such a component is inserted into the handpiece as a whole (without having to be rotated) and is designed in such a way that a direct seal is achieved with the handpiece.

The first essential embodiment of such an interface solution or coupling structure is a magnetic coupling.

In the magnetic coupling, magnets cause the external plug (of the charging cable) to couple with the closure cap. The plug is held in place by the magnetism of the closure cap It is possible for the plug to contain the magnets or for the closure cap to contain the magnets. Solutions in which both the closure cover and the plug contain magnets are conceivable.

In a preferred embodiment, the plug simply rests on the closure cap at the end and is not positioned by its shape. The correct positioning of the plug on the closure cap is achieved solely by the effect of the magnets.

Preferably, recesses are provided in the plastic body of the closure cap to accommodate the magnets. The plug then rests only on the (flat) outer side of the closure cap. The plug preferably has two contact points on its front side in the form of projections or pins, which establish the connection to two corresponding contact pins on the closure cap.

In an alternative embodiment, an auxiliary geometry may also be provided for positioning the plug on the closure cap. In this case, positioning is (additionally) carried out via guide elements that protrude from the cover (e.g. via (contact) projections or edges, etc.) and are formed correspondingly on the plug (i.e. set back for example as a recess)—or vice versa.

A second essential embodiment of the aforementioned interface solution or coupling structure is a plug coupling.

In the plug coupling, the plug is held on the closure cap by clamping or by a force/form fit. The plug is inserted into a recess in the closure cap and held there by friction or force/form fit. The desired alignment is achieved by the outer contour of the plug and the corresponding contour on the closure cap.

For both of the aforementioned embodiments of the aforementioned interface solution or coupling structure, the closure cap can also be designed so that the contact protruding from the housing (interface) is aligned essentially perpendicular to the longitudinal axis of the handpiece. This is also possible with a one-piece unit consisting of a closure cap and an insertion unit.

The interface solutions preferably have contact pins on the inside, which protrude through the closure cap. The plastic body of the closure cap preferably has a retaining element with through recesses which accommodate the contact pins. The contact pins are preferably pressed into the closure cap.

The contact pins in the closure cap can establish the external contact directly themselves, as described above for the magnetic coupling or for the plug coupling (here, the contact pins are the contacts that are inserted into the plug or the plug socket). The pins can also be combined with a charging socket, i.e., if, for example, the plug itself does not contain any corresponding contact elements.

The contact pins are preferably arranged at a distance of approximately 2 mm to approximately 10 mm, more preferably at a distance of approximately 2.5 mm to approximately 5 mm. The plug has corresponding or identical dimensions.

The following describes how the electrical contact is established from the closure cap to the insertion unit and which components are preferably used for this purpose.

First, the spring plates are described, which are used to bring the inner ends of the contact pins of the closure cover into contact during assembly and which themselves are connected to the printed circuit board of the corresponding device.

Preferably, a spring plate is used, which can alternatively also be referred to as a leaf spring.

The spring plates preferably have the shape of a mushroom cross-section halved lengthwise in order to be applied to a corresponding support body in a particularly efficient manner. The “hat” of the mushroom cross-section halved lengthwise has contact points with the printed circuit board in its upper region and guide and retaining structures (or geometries) in its lower region, which interact with corresponding guide and retaining structures (or corresponding geometries) of the support body, if necessary.

The “stem” of the mushroom cross-section halved lengthwise is designed at its upper and lower ends in such a way that it interacts with corresponding guide and retaining structures of the spring support body. Spring contact points are provided in the middle of the stem, at which electrical contact is established with the inward-facing ends of the contact pins of the closure cap. The spring plate is arranged in a plane that runs essentially perpendicular to the longitudinal direction of the handpiece. The spring action at the spring contact points (i.e. the elastic bending of the spring plate) also takes place in this plane.

The spring support body is located at the rear end of the insertion unit, transversely to the longitudinal direction of the handpiece and essentially in the lower region thereof. The spring support body is preferably a plastic part which rests against the rear end of the insertion unit or is connected to it (preferably mechanically). The spring support body is also provided with guide and retaining structures which interact with the guide and retaining structures of the spring plate.

With regard to the mounting of a spring plate on the spring support body, it is preferably the case that the spring plate is held clamped to the spring support body by means of the guide and retaining structures, whereby the spring plate is guided around the guide and retaining structures of the spring support body. The spring plate is thus arranged in a fixed position essentially perpendicular to the longitudinal direction of the handpiece.

One or more support points are provided between the spring plate and the spring support body. The spring plate is held in position at these spring support points when the rear ends of the contact pins of the closure cover are clamped to the contact points on the stem of the respective spring plate during assembly. The support points are thus part of the guide and retaining structures of the spring plate.

Preferably, two support points are provided on each spring plate. Solutions with one support point per spring plate are also conceivable if the spring plate were to be held in place in another way or if it had a different shape. At least one end of the spring plate is arranged so that it can be moved at a spring support point (i.e., if two support points are provided) to allow deflection (i.e. the elastic bending of the spring plate apart in the area of the spring contact points on the stem when the closure cap is mounted).

The closure cap is mounted in essentially two steps. In a first step, the closure cap is inserted into the housing of the handpiece in its insertion position (which is predetermined by geometries on the edge of the cap). The plane spanned by the contact pins is oriented at an angle of approximately 0° to approximately 60° to the contact arms (hereinafter also referred to as bending sections) in the stem area of the spring plates.

In a second step, the closure cap is then rotated into its end or mounting position. The plane spanned by the contact pins now essentially forms an angle of 90° to the contact arms or bending sections of the spring sheet (in their relaxed position). The contact pins press the spring arms or bending sections elastically outward (or springily). This mechanically ensures electrical contact between the respective spring sheet and the respective contact pin. In the stem area of each of the two spring sheets, which are shaped like a mushroom cross-section halved lengthwise, there is a spring contact point at which electrical contact is established between the contact pins and the respective spring sheet.

When turned to the end position, the contact pins press the spring plates outwards by approximately 0.5 mm to approximately 5 mm, preferably by approximately 1 mm to approximately 3 mm, from the rest position.

The advantage of the above-described design is that impacts or shocks in the longitudinal direction of the insertion unit can be compensated for. In this case, the pins do not press on the spring plates but can move along the bending sections or spring arms, which helps to ensure trouble-free operation.

Alternative solutions are discussed below.

With regard to solutions using spring plates, the contact pins and the cover are provided as described above. However, the spring plates are constructed differently than in the solutions described above. The spring direction can be formed in the longitudinal direction of the insertion unit. A leaf spring or spring plate in a flat design with a protruding tongue can be provided. The leaf spring or spring plate is mounted on the spring support body. This requires different guide and retaining structures than in the previous solutions. The retaining function is achieved, for example, by rivets, clamps, and latches. The leaf spring or spring plate has a (spring) tongue that is movable in the longitudinal direction of the insertion unit. During assembly, the contact pins press with their ends on the spring tongue in the direction of insertion or in the longitudinal direction of the insertion unit. However, there is a possibility that if the device falls, the mounting pins will also press on the spring tongue. Depending on the force of the fall, the contact may be lost due to deformation of the spring tongue.

In solutions with a cable, the closure cap or the interface on the closure cap (i.e., with the contact pins) is connected to the printed circuit board by means of a cable. However, this can pose a challenge in that the solder joints may break during assembly or disassembly. In addition, the cable may break.

Another alternative solution involves attaching the cover cap to the handpiece by snapping it into place instead of using a thread or bayonet lock. In this case, the cover cap is inserted into the handpiece like a pin, i.e. a translational movement is performed instead of a rotational movement. The cover cap is attached to the housing of the handpiece by snapping it into place or by means of a screw on the insert. With this solution, no thread and no (circular) inner geometry of the handpiece housing would be required. Otherwise, however, the design would be basically identical to the embodiments with the magnetic coupling and plug coupling; the springs or spring plates would also preferably press onto the contact pins from the side so that they would not be compressed if the device were to fall.

### BRIEF DESCRIPTION OF THE DRAWINGS

Further advantageous embodiments of the invention are apparent from the following description of embodiments of the invention with the aid of the schematic drawings. In particular, the drive unit according to the invention, the electric toothbrush handle according to the invention, the manufacturing method according to the invention, the plug-on brushes according to the invention, and the electric toothbrushes according to the invention are described in more detail below with reference to the accompanying drawings and examples of embodiments. They show:

FIG. 1: a perspective view of an electric toothbrush with a vibrating drive according to the invention, viewed from the front;

FIG. 2: a perspective view of the electric toothbrush according to FIG. 1, viewed from the rear;

FIG. 3: a side view of the electric toothbrush according to FIG. 1;

FIG. 4: a top view of the top of the electric toothbrush according to FIG. 1;

FIG. 5: a top view of the back of the electric toothbrush according to FIG. 1;

FIG. 6: a longitudinal section through the electric toothbrush according to FIG. 3 in side view;

FIG. 7: a perspective view of a handpiece of the electric toothbrush according to FIG. 1 from the front;

FIG. 8: a perspective view of a handpiece of the electric toothbrush according to FIG. 1 from the rear;

FIG. 9: a longitudinal section through a handpiece of the electric toothbrush according to FIG. 1 in side view without insertion unit;

FIG. 10: a perspective view of an insertion unit for a handpiece of the electric toothbrush according to FIG. 1 without cabling from the front;

FIG. 11: a perspective view of an insertion unit for a handpiece of the electric toothbrush according to FIG. 1 without cabling from the rear;

FIG. 12: a side view of an insertion unit for a handpiece of the electric toothbrush according to FIG. 1 without cabling;

FIG. 13: a longitudinal section through an insertion unit with schematically represented components according to FIG. 12 in side view for a handpiece of the electric toothbrush according to FIG. 1 with cabling;

FIG. 14: a detailed view of an alternative embodiment of the electric toothbrush analogous to FIG. 1 with a separate end piece in longitudinal section with cabling;

FIG. 15: a detailed view of a further alternative embodiment of the electric toothbrush analogous to FIG. 1 with a separate end piece in longitudinal section with cabling;

FIG. 16: a perspective view of an alternative version of an electric toothbrush with an oscillating-rotating drive from the front;

FIG. 17: a perspective view of the alternative electric toothbrush according to FIG. 16 from the rear;

FIG. 18: a side view of an electric toothbrush according to FIG. 16;

FIG. 19: a top view of the top of an electric toothbrush according to FIG. 16;

FIG. 20: a top view of the back of an electric toothbrush according to FIG. 16;

FIG. 21: a side view of a detailed section of the rear end of an electric toothbrush according to FIG. 18 with cabling;

FIG. 22: a perspective view of an insertion unit for an electric toothbrush according to FIG. 16 from the front;

FIG. 23: a perspective view of an insertion unit for an electric toothbrush according to FIG. 16 from the rear;

FIG. 24: a side view of an insertion unit for an electric toothbrush according to FIG. 16;

FIG. 25: a detailed view of the rear end of an insertion unit for an electric toothbrush according to FIG. 16;

FIG. 26: a 3D view of a handpiece according to the invention, showing an interface with a magnetic coupling;

FIG. 27: a cross-sectional view in the area of the spring contact points of a handpiece according to FIG. 26;

FIG. 28: a 3D view of the insertion unit for an electric toothbrush;

FIG. 29: a top view of the end of the insertion unit in the unassembled state;

FIG. 30: two external views of a closure cap of the magnetic coupling in 3D;

FIG. 31: a cross-sectional view of a closure cap with magnetic coupling;

FIG. 32: a 3D view of the handpiece of an electric toothbrush with interface and plug coupling;

FIG. 33: two external views of the closure cap with plug coupling in 3D;

FIG. 34: a cross-sectional view of the closure cap with plug coupling.

### WAY(S) FOR IMPLEMENTING THE INVENTION

Certain terms are used in the following description for practical reasons and are not to be understood as limiting. The words “right,” “left,” “bottom,” and ‘top’ refer to directions in the drawing to which reference is made. The terms “inward,” “outward,” “below,” “above,” “left,” “right,” “front,” “rear” or similar are used to describe the arrangement of designated parts relative to each other, the movement of designated parts relative to each other, and the directions toward or away from the geometric center of the invention and designated parts thereof as shown in the figures. These spatial relative terms also include positions and orientations other than those shown in the figures. For example, if a part shown in the figures is turned upside down, elements or features described as “below” are then “above.” The terminology includes the words expressly mentioned above, derivatives thereof, and words of similar meaning.

In order to avoid repetition in the figures and the accompanying description of the various aspects and embodiments, certain features should be understood as common to different aspects and embodiments. The omission of an aspect in the description or a figure does not imply that this aspect is missing in the corresponding embodiment. Rather, such omission may serve to clarify and prevent repetition. In this context, the following stipulation applies to the entire further description: If a figure contains reference signs for the purpose of clarity, but these are not mentioned in the immediately associated descriptive text, reference is made to their explanation in preceding figure descriptions. Furthermore, if reference signs are mentioned in the descriptive text directly associated with a figure that are not contained in the associated figure, reference is made to the preceding and following figures. Similar reference signs in two or more figures represent similar or identical elements.

FIGS. 1 to 15 generally illustrate an electric toothbrush 1 in accordance with the present invention with an alternative design variant (vibrating drive).

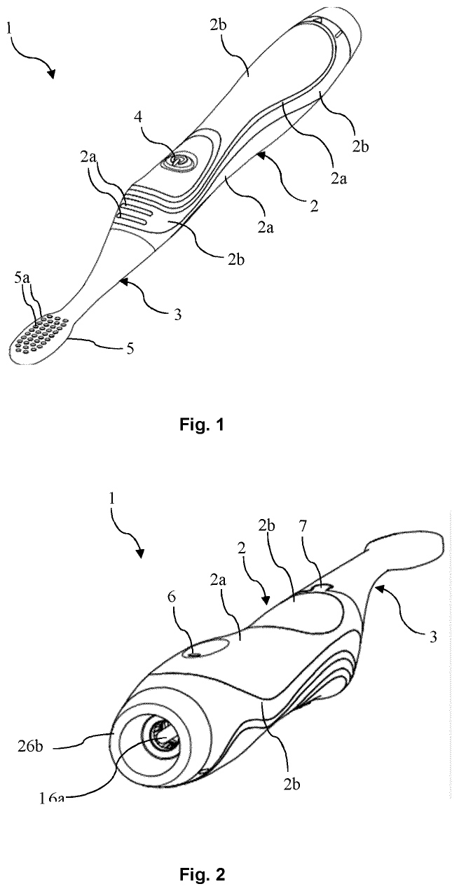

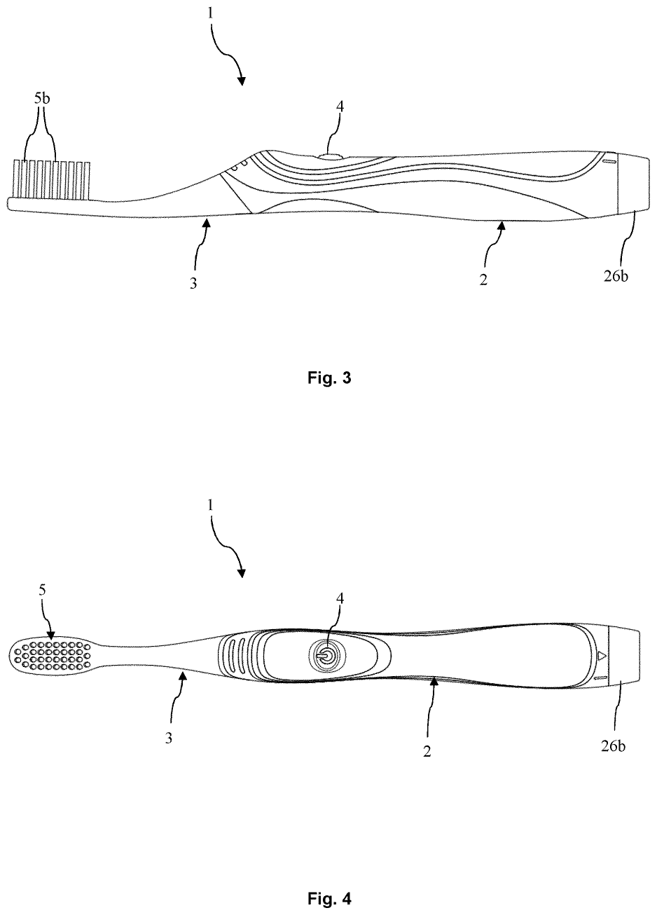

FIGS. 1-5 show the electric toothbrush 1 from different angles. The electric toothbrush comprises a handpiece 2, which has a housing made of a hard component 2a, which is provided with a soft component 2b in some areas in order to increase grip, for example. On the upper side, the toothbrush 1 has an on/off switch 4, which is also overmolded with soft component 2b. A plug-on brush 3 is attached to the front end of the handpiece 2, which does not have any bristles in FIG. 1 and FIG. 2, so that only the bristle holes 5a, which are designed as blind holes in this case, are visible on the bristle carrier 5 or brush head.

In FIGS. 3 and 4, the plug-on brush has bristles 5b, which are of the same length in this embodiment. At the rear end of the handpiece 2, the end piece 26b closes the housing of the handpiece 2 and surrounds the charging socket 16 as a kind of protective structure.

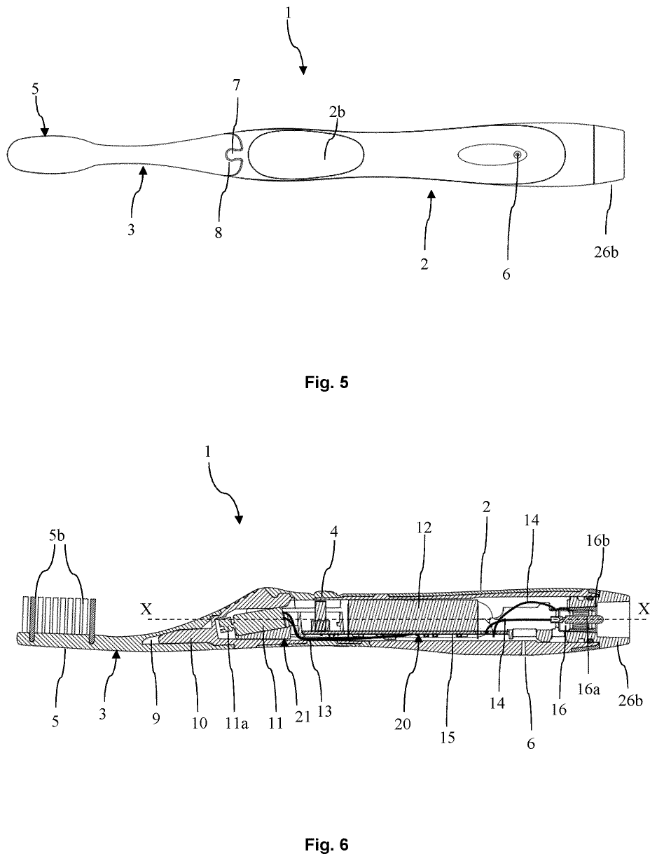

As can be seen in FIG. 5, the plug-on brush 3 has a recess 8 on the rear side, into which a corresponding cam 7 of the handpiece 2 engages, whereby a predefined pull-off force of the plug-on brush 3 can be set. On the rear side, the handpiece 2 has a surface with a soft component 2b opposite the on/off switch 4, which in turn ensures a better grip. Furthermore, a through hole with a pressure equalization element 6 is provided in the rear end area on the rear side of the handpiece 2 for degassing the interior of the housing 19.

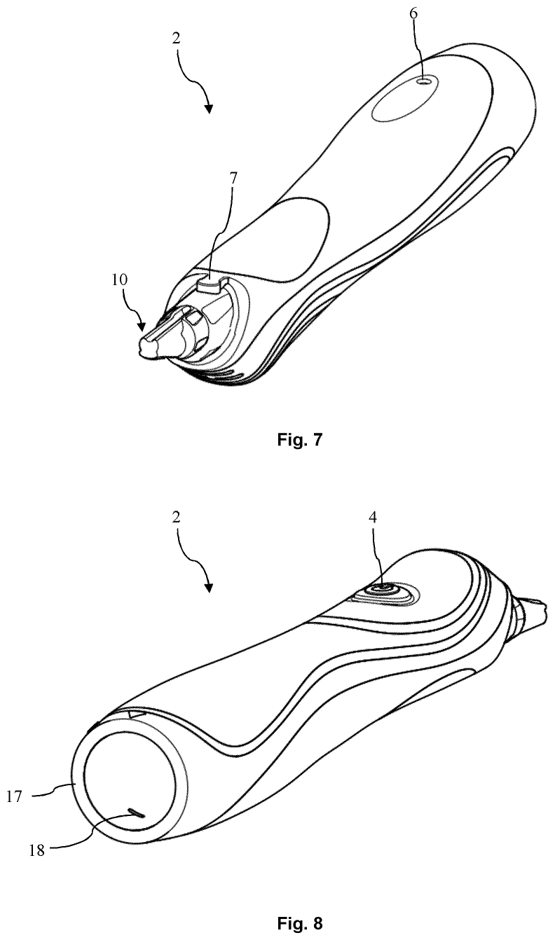

According to the sectional view in FIG. 6, the bristles 5b arranged in the blind holes (bristle holes 5a) of the bristle carrier 5 can be seen. Furthermore, the insertion unit 20 inserted into the handpiece 2 can be seen, which comprises the insert carrier 21, on which the motor 11 with the eccentric 11a, the on/off switch 4, the battery 12, the printed circuit board 15 and the charging socket 16 with the charging socket housing 16b and the charging socket pin 16a. The charging socket 16 or the charging socket housing 16b and the charging socket pin 16a are connected via the electrical cables 14 to the printed circuit board 15 which in turn is connected to the battery 12. The motor 11 is connected to the printed circuit board 15 via the electrical cables 13 and the on/off switch 4 is arranged on the printed circuit board 15 in such a way that it can close or interrupt the circuit. The insertion unit 20 is thus configured in such a way that a closed circuit can be established with it alone. The rear end of the handpiece 2 is formed by the end piece 26b. The handpiece 2 is inserted at the front with its plug-like coupling structure 10 into the corresponding socket-type coupling structure 9 of the plug-on brush 3.

FIGS. 7 to 9 illustrate the handpiece 2 and its housing, i.e. without the plug-on brush and without the insertion unit 20. FIG. 7 shows in particular the through hole with pressure equalization element 6 in the rear area of the handpiece 2, as well as the cam 7 and the plug-type coupling structure 10, which forms the interface to the plug-on brush 3.

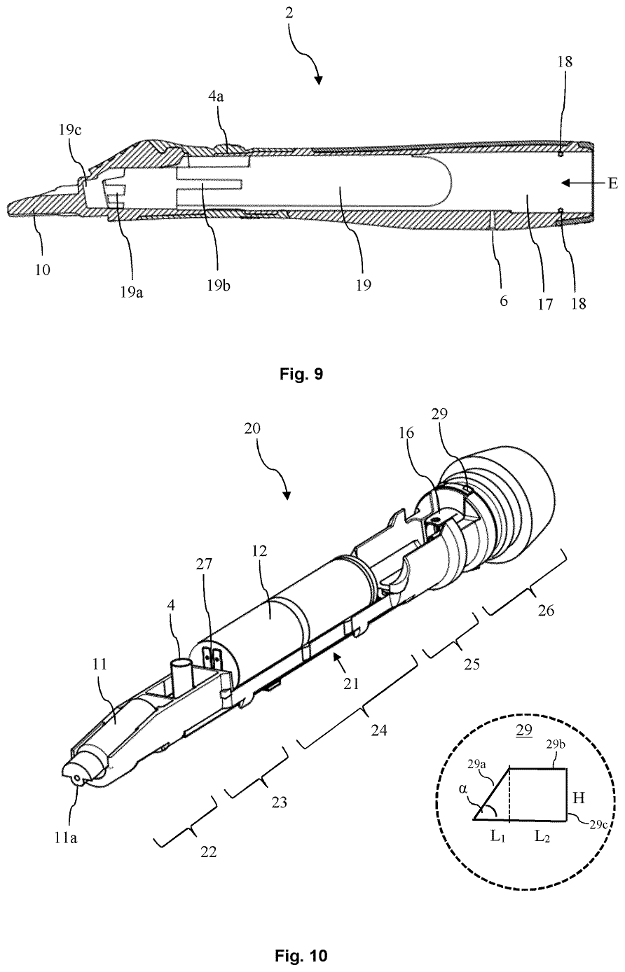

FIG. 8 shows in particular the on/off switch 4 overmolded with a soft component and the housing wall 17 with a locking recess 18 for a corresponding locking tab 29 of the insertion unit 20, which is described further below. As a rule, at least two, in this case four, locking recesses 18 are provided in the rear housing area, as shown in FIG. 9, which are arranged opposite each other on the housing wall 17 in the direction of the top or rear side. In this embodiment, positioning aids 19a and 19b for the insertion unit 20 and the insertion carrier 21, respectively, are provided in the interior of the housing 19, as well as the stop 19c for the motor 11. The insertion direction for the insertion unit 20 is indicated by the arrow E.

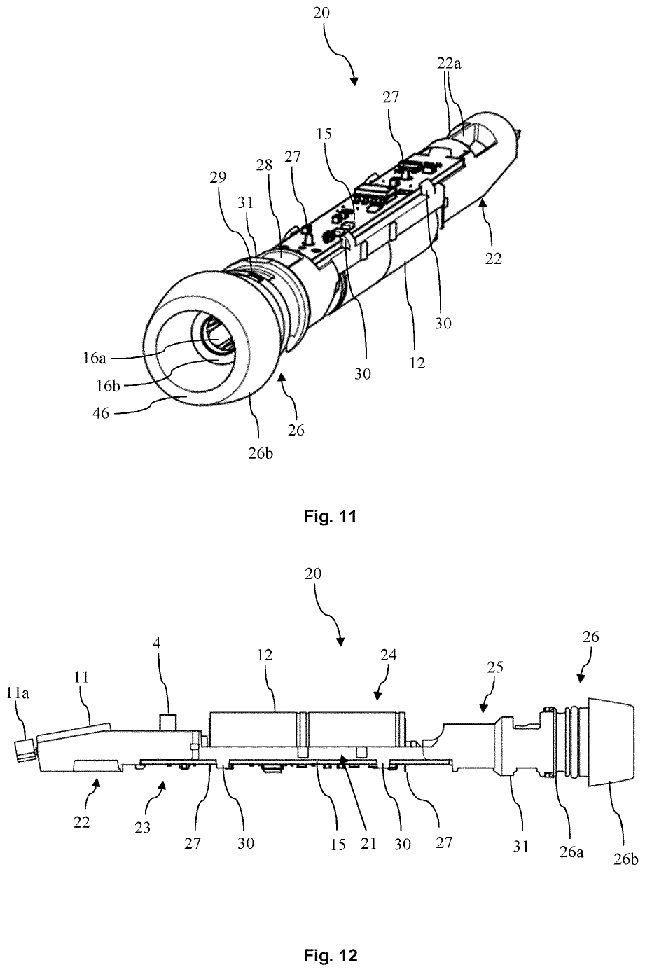

FIG. 10 shows an insertion unit 20 according to the invention taken on its own. The insertion unit 20 comprises the insertion carrier 21, which is divided into several sections for the individual components. At the front is the motor carrier 22 for the motor 11. This is followed by the switch carrier 23, which surrounds the on/off switch 4 (the switch itself is located on the printed circuit board). This is followed by the battery carrier 24, into which the battery 12 is inserted, which is in electrical contact with the printed circuit board 15 via soldered contact plates 27 (only the front contact plate is visible here). Next is the connection carrier 25, through which the electrical cables 14 are routed from the printed circuit board 15 to the charging socket 16 in the final device. The charging socket 16 is housed in the charging socket carrier 26. The charging socket carrier 26 also has locking tabs 29, which snap into the aforementioned recesses 18 in the housing wall 17 of the handpiece 2.

The detailed view shown in FIG. 10 illustrates a locking tab 29 or its wedge-shaped structure (opposite to the insertion direction E) in a side view. The locking tab 29 comprises an insertion bevel 29a which extends at an angle α from the base line of the locking tab 29, which has a length L1. The insertion bevel 29a is followed by the horizontal part 29b, which has a base line with a length L2, and a vertical wall 29c with a height H, which corresponds to the maximum height of the insertion bevel 29a.

The angle α defined by the insertion bevel 29a relative to the baseline lies in a range from 10° to 75°, preferably from 15° to 35°.

The length L1 of the base line of the insertion bevel 29a is from 0.3 mm to 3 mm, preferably from 0.5 mm to 1.5 mm.

The height H of the insertion bevel 29a is from 0.1 mm to 1.5 mm, preferably from 0.25 mm to 0.5 mm. The height H increases steadily and then transitions into the horizontal part 29b.

The horizontal part 29b comprises the base line with a length L2 of 0.1 mm to 1 mm, preferably 0.15 mm to 2 mm. The height H is between 0.1 mm and 1.5 mm, preferably 0.25 mm to 0.5 mm (i.e. corresponding to the highest point of the insertion bevel 29a).

The rear vertical wall 29c serves to actually snap into the locking recesses 18 in the housing and accordingly also has the height H.

The overall dimensions of the insertion bevel 29a are therefore L1 plus L2 in length from 0.4 mm to 4 mm, preferably from 0.65 mm to 3.5 mm, and in width (i.e., perpendicular to the longitudinal axis X or to the insertion direction E) from 0.5 mm to 3 mm, preferably from 0.8 mm to 2 mm, and in height from 0.1 mm to 1.5 mm, preferably from 0.25 mm to 0.5 mm.

In the perspective rear view shown in FIG. 11, the charging socket carrier 26 can be seen, which accommodates the charging socket 16 with the charging socket pin 16a and the charging socket housing 16b. The end piece 26b of the charging socket carrier 26 surrounds the charging socket 16 or its front end in the manner of an annular protective element, which is simultaneously configured for vertical positioning of the device by having a flat outer surface 46. Furthermore, the vertical wall 29c of the locking tab 29 and a flattening 31 on the charging socket carrier 26 as well as a through hole 28 in the area of the connection carrier 25 can be seen. The contact ends of the contact plates 27 protrude through corresponding openings in the printed circuit board 15. These are soldered to the printed circuit board 15 and connect the battery 12 to the printed circuit board 15. The printed circuit board 15 is held by holders 30 of the insertion carrier. The motor carrier 22 has two adjacent through openings 22a on its rear side with a partition wall arranged between them.

The side view of the insertion unit according to FIG. 12 essentially illustrates once again the parts and components of the insertion unit 20 according to the invention described in connection with FIG. 10.

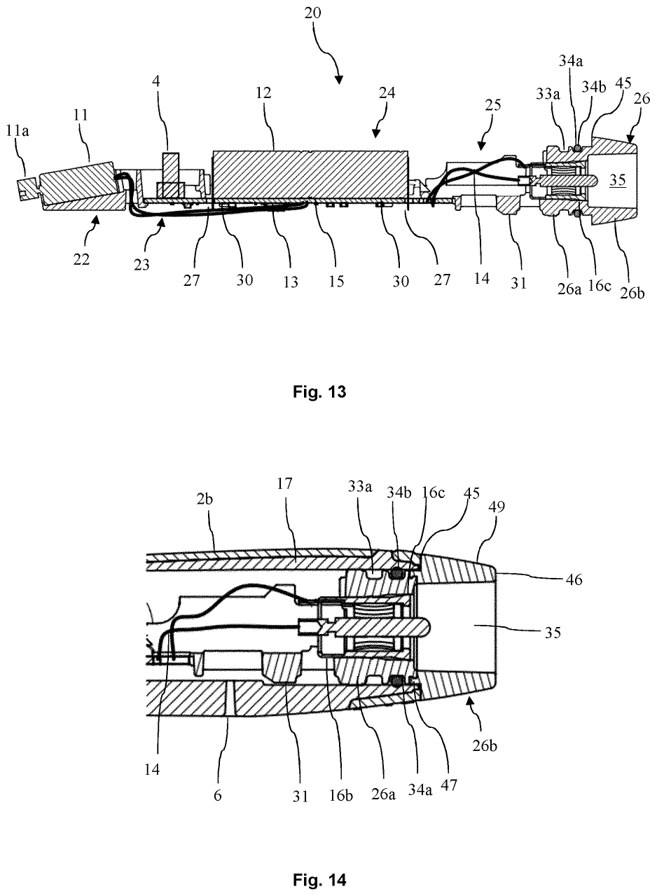

FIG. 13 shows a sectional view through the loaded insertion unit 20 according to FIG. 12 with components shown schematically. This view shows in particular the one-piece design of the charging socket carrier 26 according to this embodiment, i.e., the charging socket carrier body 26a and the end piece 26b merge into one another without interruption or coupling. The charging socket carrier body 26a encloses the charging socket 16 or the charging socket housing 16b, which surrounds the charging socket pin 16a. A corresponding plug from a power supply unit for charging the device can be plugged onto the charging socket pin 16a. The end piece 26b surrounds the charging socket 16 or its front end in the manner of a ring-shaped protective element, which is also configured for vertical positioning of the device by having a flat outer surface 46 (see FIG. 11).

One electrical cable 14 is connected to the charging socket housing 16b and the other electrical cable 14 is connected to the charging socket pin 16a. The electrical cables 14 are routed from the printed circuit board 15 through the connection carrier 25 to the charging socket housing 16b and the charging socket plug 16a, respectively. The charging socket housing 16b also comprises hook-shaped locking geometries 16c by means of which the charging socket 16 is held in the charging socket carrier body 26a. When the charging socket 16 is inserted into the charging socket carrier body 26a, the charging socket 16 is pressed against it, thereby achieving a seal to the outside. The end piece 26b comprises a circumferential projection 45 at its end facing the charging socket carrier body 26a, which can interact sealingly with an adjacent soft component area 2b of the housing. The charging socket carrier body 26a further has two circumferential grooves 33a and 34a on its outer circumference, which each serve to accommodate a corresponding sealing element or O-ring. In the present embodiment, only the groove 34a located toward the end piece 26b is fitted with an O-ring 34b. This form of sealing between the housing and the loading device carrier is usually sufficient. For safety reasons, however, groove 33a may also be fitted with an additional sealing element or O-ring 33b. It is also conceivable that only groove 33a is fitted with a sealing element or O-ring 33b. The printed circuit board 15 is held in position by the holders 30 of the insertion carrier 21. The electrical cables 13 are routed from the printed circuit board 15 under the switch carrier 23 into the motor carrier 22, where they are preferably connected to a terminal on the rear of the motor 11.

FIG. 14 shows an embodiment of the insertion unit 20 according to the invention, in which the charging socket carrier 26 has a two-part structure. The end piece 26b is locked to the charging socket carrier body 26a by means of locking devices 47 and can thus be inserted into the handpiece 2 together with the latter or as part of the insertion unit 20. When inserted, a further seal is created between the projection 45 and the adjacent soft component 2b at the rear end of the handpiece, i.e., in addition to the circumferential seal between the sealing element or O-ring 34b and the inside of the housing wall 17.

The charging socket 16 is freely accessible from the outside through the charging opening 35. The through hole with pressure equalization element is provided in the housing wall 17 toward the rear. The flattening 31 supports the connection carrier 25 against the inside of the housing wall 17. The charging socket carrier body 26a is supported circumferentially on the inside of the housing wall 17. The end piece 26b closes off the handpiece 2 towards the outside and thus forms part of the outer surface of the handpiece, in particular in the horizontal direction with its outer circumference 49, but also in the vertical direction by means of the flat outer surface 46. The charging socket 16 also forms part of the outer surface in the vertical direction with the outer part of the charging socket housing 16b and the rear end of the charging socket pin 16a.

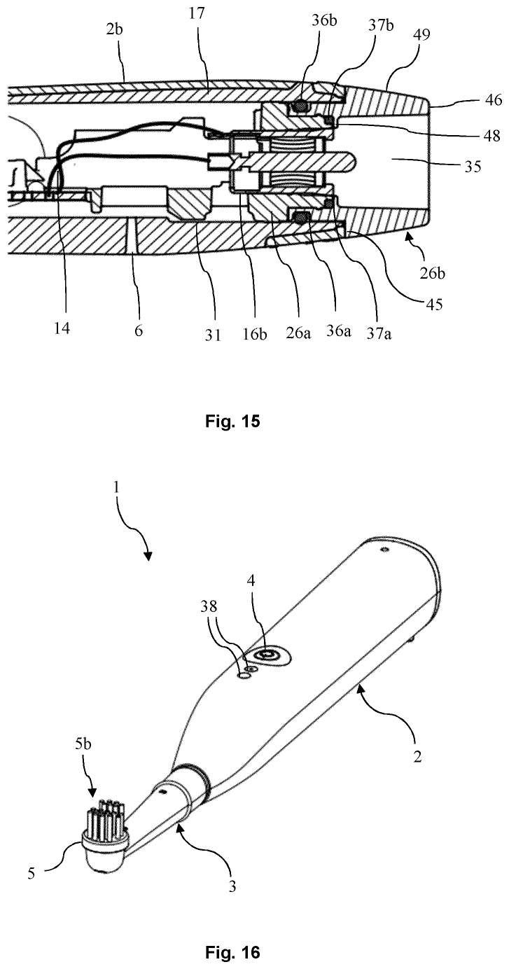

FIG. 15 shows another embodiment of the insertion unit 20 according to the invention, in which the charging socket carrier has a two-part structure. Here, the end piece 26b is attached laterally to the charging socket carrier body 26a, preferably achieving a clamping effect, and the end piece 26b is inserted into the handpiece as part of the insertion unit 20. Here too, when inserted, a seal is created between the projection 45 and the adjacent soft component 2b at the rear end of the handpiece 2, i.e. in addition to the seals between the end piece 26b and the inside of the housing wall 17 and between the end piece 26b and the charging socket carrier body 26a in the axial direction. The circumferential seal between the end piece 26b and the inside of the housing wall 17 is achieved by means of the sealing element 36b or O-ring in the groove 36a at the front end of the end piece. The axial seal between the end piece 26b and the charging socket carrier body 26a is achieved by means of the sealing element 37b or O-ring in the groove 37a at the rear end of the charging socket carrier body 26a, whereby the end piece 26b presses against the O-ring 37b with a retaining projection 48.

In this case, too, the end piece can be inserted into the device together with the charging socket carrier body or the rest of the insertion unit 20. The charging socket 16 is freely accessible from the outside through the charging opening 35. The through hole with pressure equalization element 6 is provided in the housing wall 17 towards the rear. The flattening 31 supports the connection carrier 25 against the inside of the housing wall 17. The charging socket carrier body 26a is in turn supported circumferentially on the inside of the housing wall 17. The end piece 26b also closes off the handpiece 2 towards the outside and thus forms part of the outer surface of the handpiece 2, in particular in the horizontal direction with its outer circumference 49, but also in the vertical direction by means of the flat outer surface 46. The charging socket 16 also forms part of the outer surface in the vertical direction with the outer part of the charging socket housing 16b and approximately the rear end of the charging socket pin 16a.

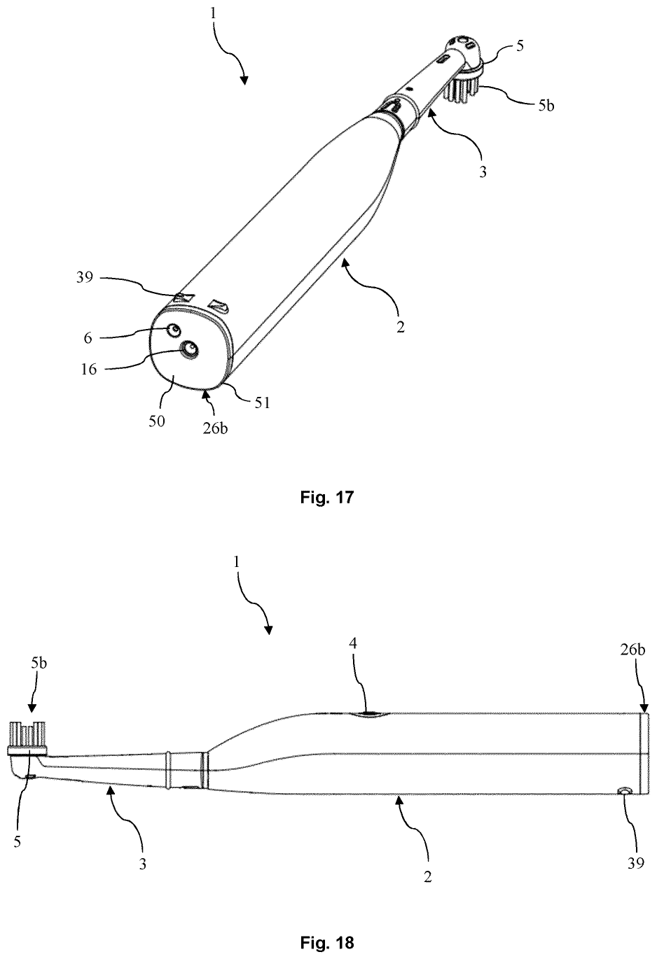

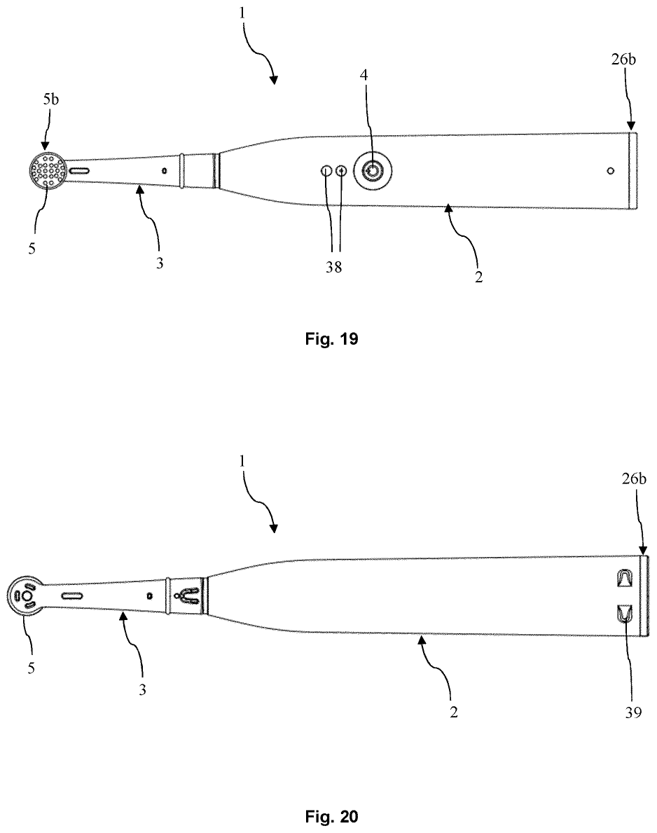

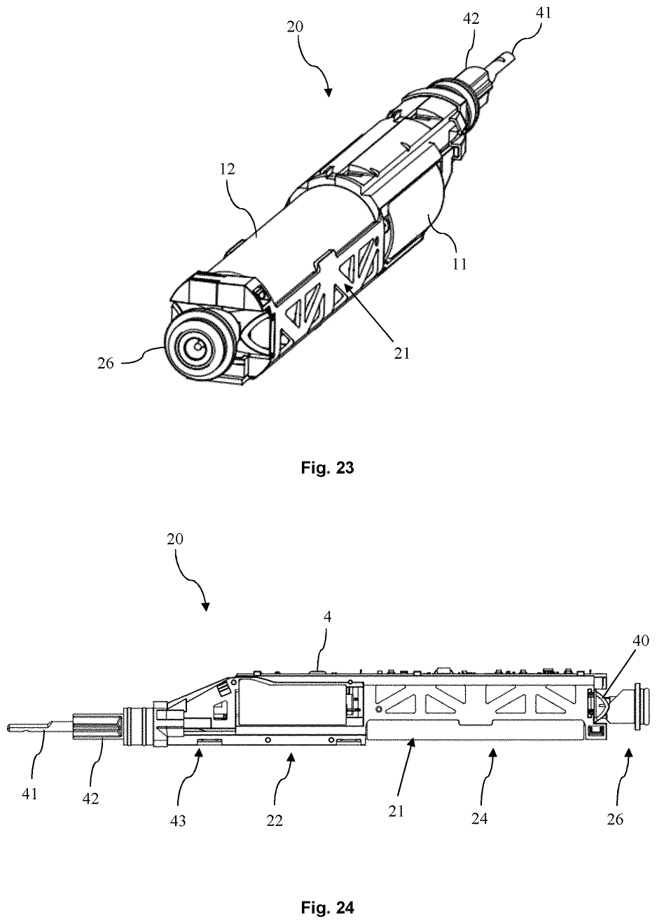

FIGS. 16 to 25 now show an embodiment of an electric toothbrush 1 with an oscillating-rotating drive, into which an alternative insertion unit 20 can be inserted.

FIGS. 16 to 20 show the electric toothbrush 1 from different angles. The electric toothbrush 1 comprises a handpiece 2, which has a housing made of a hard component 2a. The toothbrush 1 has an on/off switch 4 on the top. Above the on/off switch 4, signal elements 38, such as LED lights, are arranged in the housing, which may indicate the operating and/or charging status of the device. The handpiece 2 is connected to a plug-on brush 3 with a round bristle carrier 5 or brush head on which the bristles 5b are arranged. An end piece 26b is arranged at the rear end of the handpiece 2, which has an opening for the charging socket 16 and which closes off the handpiece 2 towards the outside, thus forming part of the outer surface of the handpiece, in particular in the longitudinal direction with its flat outer surface 50 and also perpendicular to the longitudinal direction with its outer circumference 51. In this embodiment, the through hole with pressure equalization element 6 is also located in the end piece 26b, toward the flat outer surface 50. On the back of the handpiece 2, there are also deposit structures 39 for safely depositing the handpiece 2 on its back, i.e., with the bristles 5b facing upward.

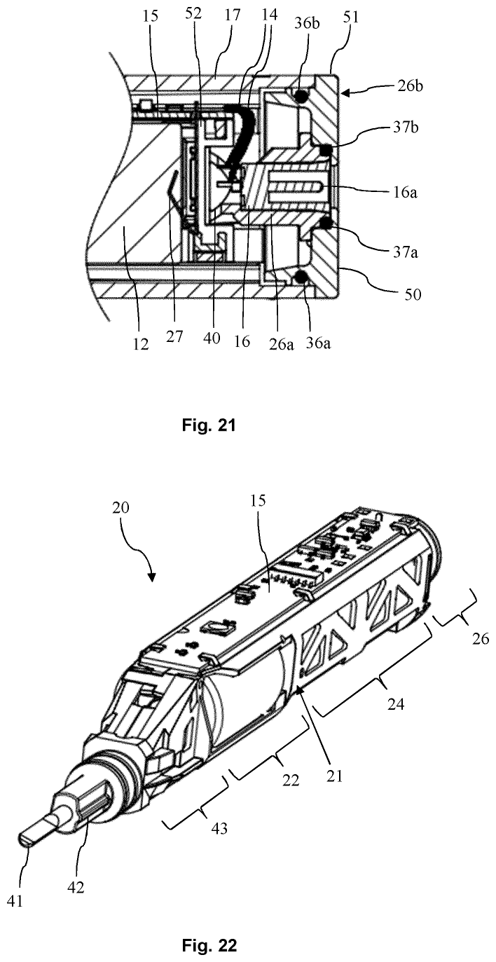

FIG. 21 shows a cross-sectional view of the rear end of the handpiece of an electric toothbrush with the insertion unit inserted as shown in FIGS. 16 to 20. The end piece 26b lies flush with the rear end of the housing wall 17, with the flat outer surface 50 forming part of the outer surface of the handpiece 2 in the longitudinal direction and the outer circumference 51 forming part of the outer surface of the handpiece perpendicular to the longitudinal direction. For lateral sealing against the housing wall 17, the end piece 26b has a sealing element or O-ring 36b, which is inserted into a corresponding groove 36a. For axial sealing of the charging socket carrier body 26a against the end piece 26b, the charging socket carrier body 26a has a groove 37a into which a sealing element 37b or O-ring is inserted, against which the end piece 26a presses in the axial direction with its inner side.

The end piece 26b locks into place with the housing and is not inserted into the handpiece together with the insertion unit 20, but is attached separately to the rear end of the handpiece, with the end piece 26b preferably locking into place on the housing wall 17. In other words, the end piece 26b as such is not part of the insertion unit 20 or the charging socket carrier 26b in this embodiment. The charging socket carrier body 26a is spring-mounted here by means of a spring bearing 40 on a support structure 52 of the insertion unit 20, which is adjacent to the battery 12 or the battery carrier 24. The electrical cables 14 coming from the printed circuit board 15 are connected to the contacts of the charging socket 16.

FIGS. 22 to 24 show the insertion unit 20 for the electric toothbrush according to FIGS. 16 to 21 in perspective view from the front and rear as well as in side view. In this embodiment of the insertion unit 20, the printed circuit board 15 is arranged on the upper side of the insertion carrier 21, wherein the insertion carrier 20 is constructed here in the manner of a monoframe which comprises a gear carrier 43 (for the gearbox that generates the rotating-oscillating movement), a motor carrier or motor zone 22, a battery carrier or battery zone 24, and a charging socket carrier 26 or charging socket carrier zone. The key element 42 (as an interface to the brush 3) is arranged at the front end of the insertion unit 20 and surrounds the drive shaft 41. Seals are provided in this front area between the drive shaft 41 and the key element 42 on the one hand and between the key element 42 and the housing on the other hand (not shown in each case). According to this embodiment, the insertion unit 20 is also configured in such a way that a closed circuit can be established with it alone.

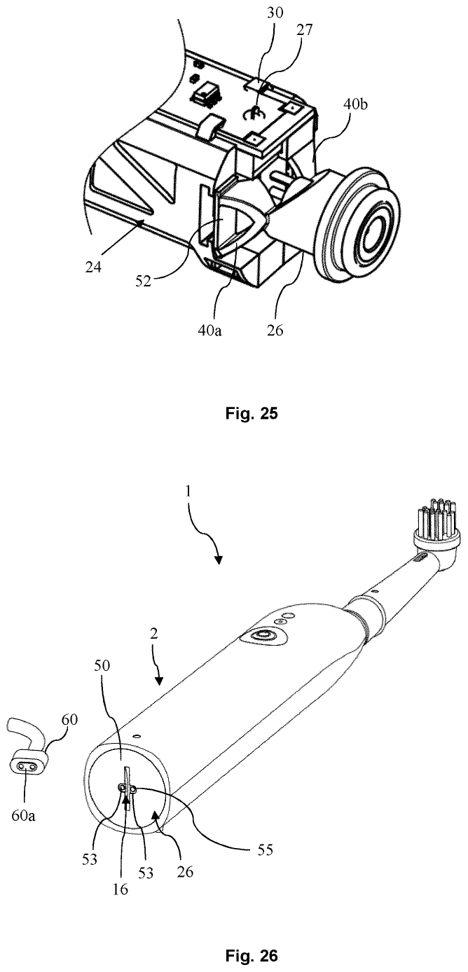

Finally, FIG. 25 illustrates a detailed view of the rear end of the insertion unit 20 according to FIGS. 22 to 24. It can be seen that the charging socket carriers 26 are mounted resiliently on the support structure 52 of the insertion unit 20 via a first spring clip 40a of the spring bearing 40 and via a second spring clip 40b of the spring bearing 40. The spring clips 40a and 40b are arranged independently of each other between the support structure 52 and the charging socket carrier 26. In this way, a particularly effective length compensation function can be provided (in this embodiment, the end piece 26b presses the insertion unit 20 into the housing). In addition, the holders 30 on the battery carrier 24, which are engaged with the top side of the printed circuit board 15, can also be seen. Furthermore, a contact plate 27 with a contact end protrudes through the printed circuit board 15.

FIG. 26 shows another embodiment of an electric personal care device or electric toothbrush 1 with a handpiece 2, which has a closure cap as a charging socket carrier 26 with contact pins 53 (as contact elements of the charging socket carrier or closure cap 26) and an otherwise essentially flat outer surface 50, wherein the closure cap 26 comprises a magnetic coupling formed by the (optional) contact projection 60a of the plug 60 and by the contact pins 53 of the closure cap 26. The rear ends of the contact pins 53 shown here are arranged in a recess 55 of the closure cap 26 and thus form the charging device or the charging socket 16. When assembled, the contact projection 60a of the plug 60 is then engaged with the rear ends of the contact pins 53 to establish electrical contact (whereby the rear ends of the contact pins 53 are preferably received in corresponding recesses of the contact projection 60a).

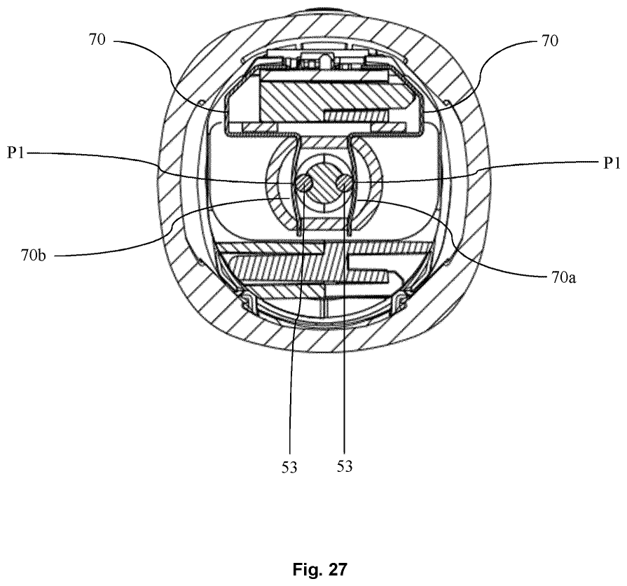

The cross-sectional view according to FIG. 27 illustrates, with regard to the functioning of the front ends of the contact pins 53 (as contact elements of the charging socket carrier or closure cap 26), the (front) ends of the contact pins directed into the handpiece, as these abut against opposite bending sections 70a, 70b of the spring plate 70 (as contact element of the insertion unit), namely at the contact points P1 between the contact pins 53 and the bending sections 70a, 70b of the spring plate 70, in order to establish electrical contact.

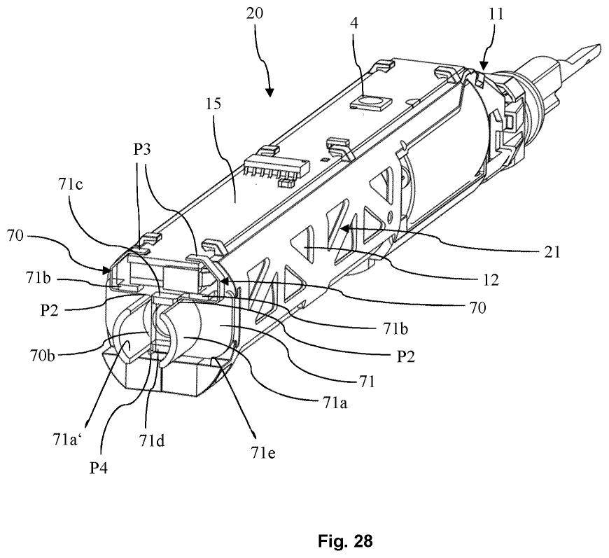

FIG. 28 illustrates the arrangement of the spring plates 70 on an insertion unit 20. At the rear end of the plug-in unit 20, a spring support body 71 is arranged as a contact element carrier, which has retaining and guide structures for the respective spring plate 70 (as a contact element of the insertion unit). In particular, the spring support body 71 has concave guide projections 71a directed vertically backwards, which leave sufficient space for the bending sections of the respective spring plate 70 to bend elastically (laterally) into their bulges 71a′ when the cover 26b is mounted. The spring support body 71 also comprises two lateral upper projections 71b, around which the spring plates 70 are each guided, and a central upper projection 71c. The support points P2 of the spring plates 70 are located between the central upper projection 71c and the upper ends of the concave guide projections 71a. At the lower end of the concave guide projections 71a or in the area of the lower retaining projection 71d of the spring support body 71, there is a support point P4 for each of the two lower end areas of the bending sections 70a, 70b of the spring plates 70. The contact points P3 between the respective spring plate 70 and the printed circuit board 15 are located on top of the printed circuit board 15. The concave guide projections 71a each protrude rearward beyond the shoulder 71e of the spring support body 71. As in the previous embodiments, the insertion unit 20 comprises the insertion carrier 21, on which the energy source 12 and the drive unit are arranged. In addition, the on/off switch 4, which is arranged on the printed circuit board 15, can be seen.

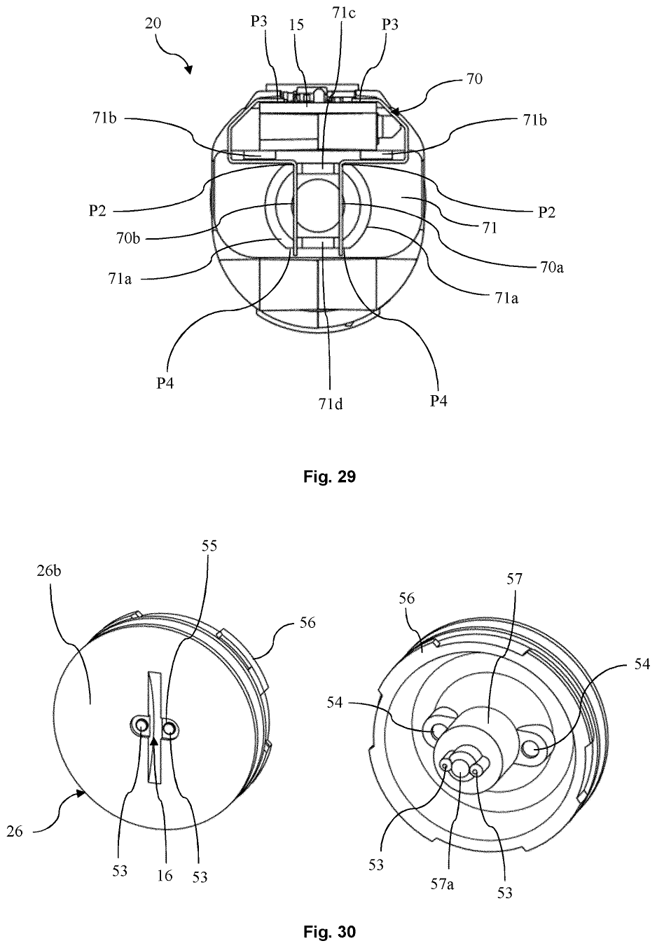

FIG. 29 is a top view of the rear end of the insertion unit 20 in the unassembled state, i.e. without a closure cap 26 attached. Consequently, the two bending sections 70a, 70b of the spring plates 70 are not bent outwards towards the concave guide projections 71a of the spring support body 71. It can be seen how the lower end regions of the bending sections 70a, 70b of the spring plates 70 each rest on the lower spring support point P4 on the lower retaining projection 71d of the spring support body 71. The two bending sections 70a, 70b of the spring plates 70 are guided between the lower retaining projection 71d and the lower ends of the concave guide projections 71a. Furthermore, it can be seen how the upper ends of the bending sections 70a, 70b of the spring plates 70 rest on the upper spring support point P2 at the upper end of the concave guide projections 71a. The two bending sections 70a, 70b of the spring plates 70 are passed between the upper retaining projection 71c and the middle upper ends of the concave guide projections 71a. In particular, the upper and lower ends of the concave guide projections 71a elastically support the bending sections 70a, 70b of the spring plates 70. The upper end sections of the spring plate 70 rest on the contact points P3 on the printed circuit board 15, thereby establishing electrical contact with it.

FIG. 30 shows a charging device carrier or a closure cap 26 with a magnetic coupling. On the outside of the closure cap 26, recess 55 can be seen with contact pins 53 (i.e. the charging device or charging socket 16) arranged therein, which, if necessary, establish contact with contact projection 60a of plug 60 according to FIG. 26. The locking projections 56 are arranged on the edge of the closure cap 26, for example for a bayonet lock (i.e. with the rear end of the handpiece). On the inside of the closure cap 26, the contact pins 53 are arranged in a retaining element 57 (as a charging socket carrier body). The ends of the contact pins 53 protruding from the retaining element 57 are separated from each other by an upper retaining element section 57a. On preferably opposite sides of the retaining element 57, magnets 54 are arranged on the underside of the closure cap 26b, which interact with the plug 60 according to FIG. 26, which may be made of metal or may in turn have corresponding magnets. The contact pins 53 of the closure cover 26 and the contact projection 60a (with the corresponding recesses) of the plug 60 can thus be brought into contact with each other virtually by themselves or automatically. The round shape of the closure cover 26, which is necessary for the rotational movement during assembly, requires a round shape of the inner cross-section of the handpiece 2.

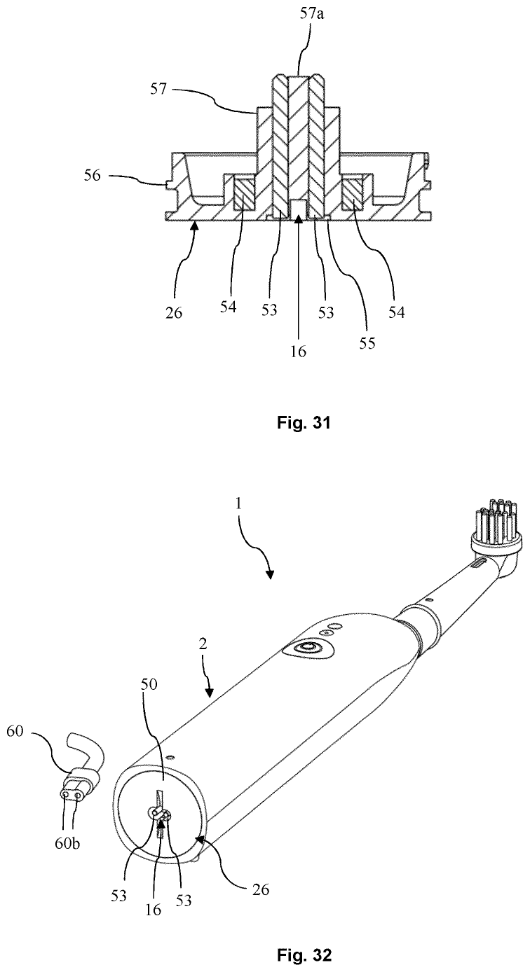

The sectional view shown in FIG. 31 illustrates once again how the contact pins 53 of the closure cap 26 are arranged within the retaining element 57, with the protruding upper ends being separated from the upper retaining element section 57a. The magnets 54 are arranged on the underside of the closure cap 26 next to the retaining element 57. The lower or rear ends of the contact pins 53 are arranged in the recess 55 and preferably do not protrude beyond the rear side of the closure cap 26. The recess 55 is not particularly deep here in order to make the magnetic coupling with the contact projection 60a of the plug 60 according to FIG. 26 particularly effective.

FIG. 32 shows another embodiment of an electric personal care device or electric toothbrush 1 with a handpiece 2, which has a closure cap 26b with contact pins 53 and an otherwise essentially flat outer surface 50, wherein the closure cover 26 comprises a plug coupling, which is formed by the contact elements or socket 60b of the plug 60 and by the contact pins 53 of the closure cap 26. The rear ends of the contact pins 53 shown here are arranged in a recess 55 of the closure cover 26, thereby forming the charging device or charging socket 16. When assembled, the socket 60b of the plug 60 is inserted into the recess 55 of the cover 26 or placed on the contact pins 53.

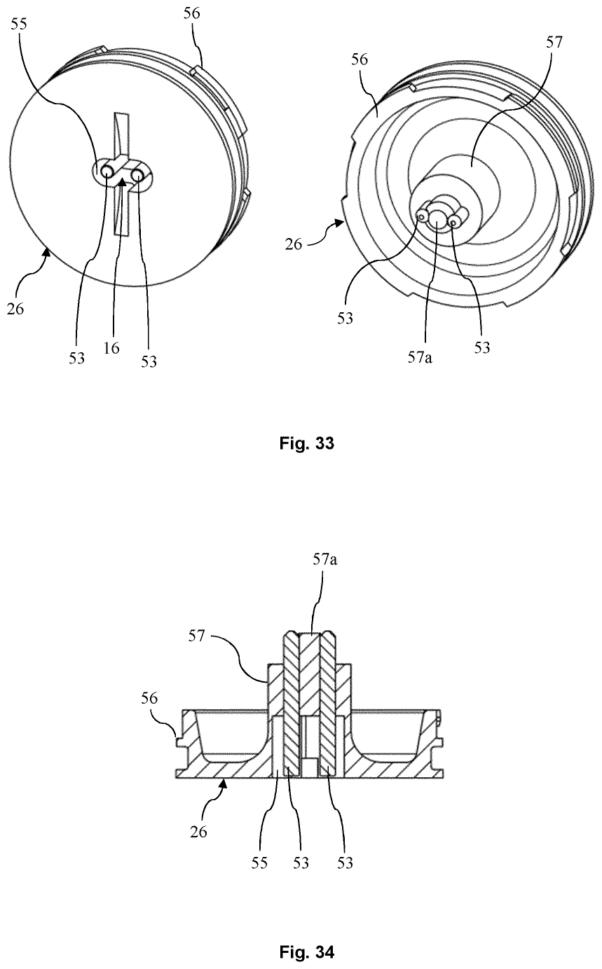

FIG. 33 shows a charging socket carrier or a closure cap 26 with such a plug coupling in detail. On the outside of the closure cap 26, you can see the recess 55 (which is correspondingly deeper than in the embodiment with the magnetic coupling) with the contact pins 53 (i.e. the charging device or charging socket 16) arranged therein, onto which the socket 60b of the plug 60 according to FIG. 32 may be applied. The locking projections 56 are arranged on the edge of the closure cap 26, for example for a bayonet lock (i.e. with the rear end of the handpiece). On the inside of the locking cover 26, the contact pins 53 are arranged in a retaining element 57 (as a charging device carrier body). The front ends of the contact pins 53 protruding from the retaining element 57 are separated from each other by an upper retaining element section 57a. The round shape of the closure cap 26, which is necessary for the rotational movement during assembly, requires a round shape of the inner cross-section of the handpiece 2.

The sectional view shown in FIG. 34 illustrates once again how the contact pins 53 of the closure cap 26 are arranged within the retaining element 57, with the protruding upper ends being separated from the upper retaining element section 57a. No magnets are arranged on the underside of the closure cap 26b. The lower or rear ends of the contact pins 53 are arranged in the deeper recess 55 for receiving the socket 60b of the plug 60 according to FIG. 32 and preferably do not protrude beyond the rear side of the closure cap 26.

Although the invention is illustrated and described in detail by means of the figures and the accompanying description, this illustration and detailed description are to be understood as illustrative and exemplary and not as limiting the invention. In order not to obscure the invention, well-known structures and techniques may not be shown and described in detail in certain cases. It is understood that those skilled in the art may make changes and modifications without departing from the scope of the following claims. In particular, the present invention covers further embodiments with any combinations of features that may differ from the explicitly described combinations of features.

The present disclosure also encompasses embodiments with any combination of features mentioned or shown above or below in various embodiments. It also encompasses individual features in the figures, even if they are shown there in connection with other features and/or are not mentioned above or below. The alternatives of embodiments described in the figures and the description and individual alternatives of their features may also be excluded from the subject matter of the invention or from the disclosed subject matter. The disclosure includes embodiments that exclusively comprise the features described in the claims or in the embodiments, as well as those that comprise additional other features.

Furthermore, the term “comprise” and derivatives thereof do not exclude other elements or steps. Likewise, the indefinite article “a” or “an” and derivatives thereof do not exclude a plurality. The functions of several features listed in the claims may be fulfilled by a single unit or step. The mere fact that certain dimensions are listed in different dependent claims does not mean that a combination of these dimensions cannot be used advantageously. The terms “essentially”, “about”, “approximately” and the like in connection with a property or value also define the property or value precisely. The terms “about” and “approximately” in connection with a given numerical value or range may refer to a value or range that is within 20%, within 10%, within 5% or within 2% of the given value or range. All reference signs in the claims are not to be understood as limiting the scope of the claims.

### LIST OF REFERENCE SIGNS

1 electric personal care device respectively electric toothbrush
2 handpiece
2a hard component (housing)
2b soft component
3 plug-on brush
4 on/off switch
5 bristle carrier
5a bristle holes
5b bristles
6 through hole with pressure equalization element
7 cam (handpiece)
8 recess (plug-on brush)
9 socket-type coupling structure (plug-on brush)
10 plug-type coupling structure (handpiece)
11 drive unit respectively motor
11a eccentric
12 power source respectively battery
13 electrical cables (to the motor)
14 electrical cables (to the charging socket)
15 printed circuit board
16 charging device respectively charging socket
16a charging socket pin
16b charging socket housing (metal)
16c locking geometry (hook-shaped)
17 housing wall (handpiece)
18 locking recesses in housing wall (open or blind hole)
19 housing interior
19a positioning aids
19b positioning aids
19c stop for the motor
20 insertion unit
21 insertion carrier
22 motor carrier
22a through openings
23 switch carrier
24 battery carrier
25 connection carrier
26 charging device carrier (charging socket carrier)
26a charging device carrier body
26b end piece
27 contact plates
28 through hole
29 locking tabs (charging device carrier)
29a insertion bevel
29b horizontal part
29c vertical wall
30 holders for printed circuit board
31 flattening
33a first groove
33b first sealing element (O-ring)
34a second groove
34b second sealing element (O-ring)
35 charging opening
36a groove
36b sealing element (O-ring)
37a groove
37b sealing element (O-ring)
38 signal elements
39 deposit structures
40 spring bearing (for charging socket)
40a spring clip
40b spring clip
41 drive shaft
42 key element
43 gear carrier
45 circumferential projection end piece
46 flat outer surface end piece
47 locking devices end piece
48 retaining projection end piece
49 outer circumference end piece
50 flat outer surface
51 outer circumference end piece
52 support structure
53 contact pins (contact elements of the closure cap)
54 magnets
55 recess
56 locking projections
57 retaining element
57a upper retaining element section
60 plug
60a contact projection
60b socket
70 spring plate (contact element of the insertion unit)
70a bending section
70b bending section
71 spring support body (contact element carrier)
71a concave guide projections
71a′ bulges
71b lateral upper retaining projections
71c central upper retaining projection
71d lower retaining projection
71e lower shoulder
E arrow insertion direction of insertion unit
X longitudinal axis (handpiece)
L₁ length of bevel (locking nose)
L₂ length of horizontal part (locking nose)
H height (locking nose)
α angle (slope)
P1 contact point bending sections—contact pins
P2 upper spring support point
P3 contact point spring plate—printed circuit board
P4 lower spring support point

1. An insertion unit for a handpiece of an electric personal care device comprising an insertion carrier on which a drive unit, an on/off switch, a power source, a printed circuit board and a charging device are arranged, wherein
the insertion unit is configured such that a closed circuit can be established with it alone, wherein
the insertion carrier comprises a charging device carrier in the area of the charging device, and wherein the charging device carrier and/or the charging device form part of the outer surface of the handpiece when assembled.

2. The insertion unit according to claim 1, wherein the charging device comprises a plug-in device, a charging socket for a power supply unit with a corresponding plug.

3. The insertion unit according to claim 1, wherein the charging device comprises an inductive device.

4. The insertion unit according to claim 1, wherein the charging device carrier comprises a charging device carrier body and an end piece.

5. The insertion unit according to claim 1, wherein the charging device carrier is formed in one piece.

6. The insertion unit according to claim 1, wherein the charging device carrier is designed in multiple parts.

7. The insertion unit according to claim 1, wherein, in the case of a multi-part design of the charging device carrier, the latter comprises a separate end piece which can be locked into place with the charging device carrier body.

8. The insertion unit according to claim 1, wherein, in the case of a multi-part design of the charging device carrier, the latter comprises a separate end piece which can be attached to the charging device carrier body.

9. The insertion unit according to claim 1, wherein the charging device has one or more locking geometries which are configured to seal the charging device against the charging device carrier body by pressing when assembled.

10. The insertion unit according to claim 1, wherein the charging device carrier body has a first sealing zone opposite a housing of a handpiece, in the form of a first groove (33a) for receiving a first sealing element, which are configured to seal the insertion unit against the housing wall of the handpiece when assembled.

11. The insertion unit according to claim 1, wherein the charging device carrier body has a second sealing zone opposite a housing of a handpiece, in the form of a second groove (34a) for receiving a second sealing element, which are configured to effect a seal of the insert unit relative to the housing wall of the handpiece when assembled.

12. The insertion unit according to claim 1, wherein the charging device carrier body has a sealing zone opposite the end, preferably in the form of a groove for receiving a sealing element, which is configured to seal the charging device carrier body against the end piece when assembled.

13. The insertion unit according to claim 1, wherein the end piece has a sealing zone opposite the housing of a handpiece, in the form of a groove for receiving a sealing element, which are configured to effect a seal of the insert unit relative to the housing of the handpiece when assembled.

14. The insertion unit according to claim 1, wherein the charging device and/or the charging device carrier body form a part of the outer surface of the handpiece which runs essentially perpendicular to the longitudinal axis of the handpiece.

15. The insertion unit according to claim 1, wherein the end part of the charging device carrier forms a part of the outer surface of the handpiece which runs essentially parallel to the longitudinal axis of the handpiece.

16. The insertion device according to claim 1, wherein the end piece of the charging device carrier forms a substantially ring-shaped protective element for the charging device.

17. The insertion unit according to claim 1, wherein one or more locking tabs are arranged on the charging device carrier body, which are configured to lock into corresponding locking recesses in the housing wall of the handpiece when assembled.

18. The insertion unit according to claim 1, wherein the locking tabs have a wedge-like shape with an insertion bevel, a horizontally extending part and a substantially vertical rear wall.

19. The insertion unit according to claim 1, wherein the charging device carrier is resiliently mounted on a support structure by means of a spring bearing.

20. The insertion unit according to claim 1, wherein the spring bearing comprises a first spring clip and a second spring clip.

21. A handpiece for an electric personal care device comprising a housing and an insertion unit according to claim 1 insertable therein.

22. An electric personal care device comprising a handpiece according to claim 21.

23. An insertion unit for a handpiece of an electric personal care device comprising an insert carrier on which a drive unit, an on/off switch, a power source, a printed circuit board and a contact element carrier are arranged, wherein
the insertion unit is configured such that a closed circuit can be established with it alone, wherein
two contact elements are arranged on the contact element carrier wherein
the contact element carrier and the contact elements are configured to ensure elastic bending of the contact elements by contact elements of a charging device carrier during assembly.

24. The insertion unit according to claim 23, wherein the contact elements arranged on the contact element carrier are each designed in the form of a spring plate.

25. The insertion unit according to claim 23, wherein the contact elements of the loading device carrier are designed in the form of contact pins.

26. The insertion unit according to claim 23, wherein the charging device carrier is designed in the form of a closure cap for the handpiece.

27. The insertion unit according to claim 23, wherein the closure cap comprises a retaining element into which the contact pins are inserted in such a way that their rear and front ends protrude freely from the retaining element, wherein the rear ends can be engaged with a plug and the front ends can be engaged with the contact elements of the contact element carrier.

28. The insertion unit according to claim 23, wherein the spring plates have the shape of a mushroom cross-section halved lengthwise, with elastic bending sections which engage with the contact pins of the closure cap when the cover cap is mounted.

29. The insertion unit according to claim 23, wherein the contact element carrier has concave guide projections between which the elastic bending sections of the spring plate arranged on the contact element carrier pass through in such a way that they can be moved into the bulges of the concave guide projections during assembly.

30. The insertion unit according to claim 23, wherein the charging device carrier has at least one magnetic element which is configured to interact with an external plug so that the plug comes into electrical contact with a charging device of the charging device carrier virtually by itself.

31. A handpiece for an electric personal care device comprising a housing, an insertion unit that can be inserted therein and a charging device carrier according to claim 23.

32. An electric personal care device comprising a handpiece according to claim 31.
